(19) United States
(12) Patent Application Publication
(10) Pub. No.: US 2013/0330848 A1
(43) Pub. Date: Dec. 12, 2013

(54) OBSERVATION DEVICE, INSPECTION DEVICE, METHOD FOR MANUFACTURING SEMICONDUCTOR DEVICE, AND SUBSTRATE SUPPORT MEMBER

(71) Applicants: Kazuharu Minato, Yokohama-shi (JP); Takeshi Inoue, Yokohama-shi (JP)

(72) Inventors: Kazuharu Minato, Yokohama-shi (JP); Takeshi Inoue, Yokohama-shi (JP)

(21) Appl. No.: 14/001,354

(22) PCT Filed: Feb. 17, 2012
(86) PCT No.: PCT/JP2012/053864

§ 371 Date: Aug. 23, 2013

(30) Foreign Application Priority Data
Feb. 25, 2011 (JP) 2011-040921

(51) Int. Cl. G01N 21/956

(52) U.S. Cl. CPC G01N 21/956
USPC 438/16; 356/237.5; 248/346.4; 248/346.03

(57) ABSTRACT

The present invention suppresses reductions in inspection precision caused by reflected and scattered light produced by wafer holders. In a wafer holder (10) that has protruding support parts (11) that contact and support a wafer and groove parts (12) that are separated from the wafer, the protruding support parts (11) are extended continuously from a part that supports one edge of the wafer to a part that supports the other edge of the wafer. Connecting parts (13) that connect adjacent protruding support parts (11) are provided in each of the vicinity of the parts supporting the one edge and the vicinity of the parts supporting the other edge.

### TECHNICAL FIELD

The present invention relates to a substrate observation apparatus and inspection apparatus, a substrate support member, and a method for manufacturing semiconductor devices.

### BACKGROUND ART

While miniaturization of semiconductors is said to be approaching its limit, mounting semiconductor chips three-dimensionally has such merits as improving performance, saving electric power, saving space, etc., and thus is spreading rapidly, along with miniaturization of semiconductors, as a means for improving additional value. Three-dimensional mounting is a technique of thinning a plurality of semiconductor chips to the extent of 10 to 50 μm, and then stacking the same. Each of the stacked chips finally becomes as thin as 10 to 50 μm, while a number of electrodes or vias which penetrate through the chips are used to electrically connect the vertical layered chips (TSV: Through-Silicon Via). In this manner, it is possible to electrically connect the chips at a shorter distance than the conventional SiP (System in a Package) in which chips are horizontally aligned and connected. Therefore, compared with the conventional SiP (System in a Package) in which chips are horizontally aligned and connected, it is more efficient in achievement of improving the operation speed of elements, saving electric power, and saving space.

There are a variety of methods for forming the TSV (Through-Silicon Via) such as in the cases of carrying out the formation before forming elements on the semiconductor chips, carrying out the formation after forming elements on the semiconductor chips, etc. In any of these cases, however, each TSV is formed by forming a deep hole tiny in diameter on a wafer (silicon substrate), and then filling the hole with a highly conductive substance such as copper or the like after covering the lateral wall of the hole with an insulation film. On this occasion, inspections are important in the process of forming the TSVs and after the TSVs are formed, and these inspections are carried out by breaking the wafer, and observing the same with an SEM (Scanning Electron Microscope), TEM (Transmission Electron Microscope) or the like. With this method, whereas it is possible to observe an actual shape of the cross section, the inspection is destructive, and takes time.

On the other hand, although there are also methods for observing the surface of a wafer with a microscope or the like, it is merely possible to confirm the condition of the wafer surface with such methods. Further, although transmission images are also observed with microscopes using infrared light, because only a very small area is observable at one time, it is not practical to inspect the TSVs in the whole wafer surface with such a method.

However, there are techniques of inspecting a repetitive pattern formed on a semiconductor wafer according to variation in diffracted light, polarization state, etc. (see Patent Literature 1, for example). According to such a method, it is possible to inspect a wide area in a short time, as well as to detect, in a short time with a good sensitivity, any abnormity due to focus variation or dose (exposure energy) variation of an exposure device for forming the pattern, and any abnormity arising from some defect or maladjustment of a processing device. Further, as a substrate support member of an inspection apparatus using this method, a wafer holder 500 is known to be configured, as shown in FIGS. 18(a) and 18(b) for example, to suck and hold a wafer W by letting a vacuum pump or the like apply a negative pressure to a plurality of suction grooves 512 formed to align concentrically in the support surface for the wafer W. Further, as another example of the substrate support member, such configuration is also known as to suck and hold a wafer by supporting the same with a plurality of small cylindrical support portions.

### CITATION LIST

### Patent Literature

PATENT LITERATURE 1: U.S. Pat. No. 7,298,471

### SUMMARY OF INVENTION

### Technical Problem

However, with conventional inspection apparatus using the method of inspecting a repetitive pattern formed on the semiconductor wafer according to the variation in diffracted light, polarization state, etc., because the wavelength of illumination light is in the wavelength range of visible light to deep ultraviolet light, it is only possible to inspect the abnormity in the diameter and opening parts of TSVs in the wafer surface, i.e., the condition in the vicinity of the wafer surface, but it is not possible to inspect the abnormity in deep parts of the TSV holes. To address this problem, such devices are being developed as to obtain the diffracted light from the TSV structure inside a wafer by setting the wavelength of the illumination light to be in the wavelength range of infrared, and using the fact that infrared light has a high transmittance to silicon which is the material of the wafer.

When acquiring an image based on the diffracted light from the wafer as an inspection image of the wafer by using infrared light to irradiate the wafer supported by the conventional substrate support member as described earlier, then part of the irradiated infrared light is transmitted to the opposite side of the wafer. Therefore, other than the diffracted light from the wafer to be inspected, reflected and scattered light from the edges and the like of the support portions (the suction grooves 512) of the substrate support member may reach the camera of a light receiving system, and become noise in the inspection image as shown in FIG. 18(a), and thereby the inspection precision is liable to reduction.

The present invention is made in view of such problems, and an object thereof is to suppress the reduction in inspection precision due to the reflected and scattered light arising from the substrate support member.

### Solution to the Problem

In order to achieve such object as above, an aspect of the present invention provides an observation device including: a substrate support member supporting a substrate; an illumination section irradiating the substrate supported by the substrate support member with illumination light having transmittance with respect to the substrate; and a light detection section detecting light from the substrate irradiated with the illumination light, wherein the substrate support member has a protruding support portion which contacts with the substrate when supporting the substrate, and a separate portion which is located apart from the substrate; and wherein in a part of the substrate support member supporting an observation area to be observed on the substrate, the support portion and the separate portion of the substrate support member do not have any line or plane orthogonal to an incidence plane of the illumination light to the substrate.

Further, in the observation device described above, it is possible to use infrared of a wavelength equal to or longer than 700 nm as the illumination light.

Further, the observation device described above may further include a transport device transporting the substrate to the substrate support member, wherein the transport device has a holding member which holds an edge portion of the substrate when transporting the substrate; the substrate support member has a relief portion formed not to contact with the holding member when the transport device transports the substrate to the substrate support member; and the substrate support member is arranged not to have any line or plane orthogonal to the incidence plane of the illumination light in a part of the relief portion supporting the observation area.

Further, in the observation device described above, the substrate support member may be configured to suck and hold the substrate by sucking air from a space formed by the supported substrate and the support portion so as to cause pressure reduction in the space; and a suction portion may be provided to suck the air in a part of the substrate support member supporting the other area than the observation area.

Further, in the observation device described above, between the support portion and another support portion adjacent to the former support portion, a pressure reduction auxiliary portion may be provided to prevent inflow of air or gas from outside into the space formed by the supported substrate and the support portions.

Further, in the observation device described above, the support portion may extend along the incidence plane of the illumination light.

Further, in the observation device described above, the support portion may have a linear portion extending from one end to the other end of the observation area along the incidence plane of the illumination light.

Further, the observation device described above may further include a rotary section which rotates the substrate support member about an axis vertical to the incidence plane of illumination light. Further, in the observation device described above, on a surface of the substrate support member facing the substrate, a layer of an infrared absorber may be formed to absorb infrared; the light detection section may have a cooled image sensor; and the illumination section may have a telecentric optical system which causes the illumination light to become parallel light to illuminate the substrate.

Further, another aspect of the present invention provides an inspection device including: the observation device described above; and an inspection section which inspects whether or not there is an abnormity in the substrate based on a detection signal of the light detected by the light detection section of the observation device.

Further, still another aspect of the present invention provides a method for manufacturing a semiconductor device, the method including: an exposing step of exposing a predetermined pattern onto a surface of a substrate; an etching step of etching the surface of the substrate according to the exposed pattern; and an inspecting step of inspecting the substrate with the pattern formed in the surface through the exposing or the etching, wherein the inspection device according to the present invention is used to carry out the inspecting step.

Further, still another aspect of the present invention provides a substrate support member including: protruding support portions which support a substrate by contacting with the substrate; and a separate portion which is located apart from the substrate, wherein the protruding support portions extend continuously from a part supporting one end of the substrate to a part supporting the other end, and have connection portions which connect adjacent ones of the protruding support portions, respectively in the vicinity of the part supporting the one end and in the vicinity of the part supporting the other end.

Further, in the substrate support member described above, the protruding support portions may each be formed into an approximate cuboid.

Further, in the substrate support member described above, in the vicinity of each of the connection portions and in the ambit enclosed by the adjacent ones of the protruding support portions and the connection portions, a suction portion may be provided to be capable of sucking air from a space formed by the supported substrate and the support portions.

Further, still another aspect of the present invention provides an observation device including: a substrate support member supporting a substrate; an illumination section irradiating the substrate supported by the substrate support member with illumination light having transmittance with respect to the substrate; and a light detection section detecting light from the substrate irradiated with the illumination light, wherein the substrate support member has a protruding support portion which contacts with the substrate when supporting the substrate, and a separate portion which is located apart from the substrate; and wherein in a part of the substrate support member supporting an observation area to be observed on the substrate, the support portion and the separate portion of the substrate support member intersect an incidence plane of the illumination light to the substrate at an acute angle or obtuse angle.

### Advantageous Effects of Invention

According to the present invention, it is possible to suppress the reduction in inspection precision due to the reflected and scattered light arising from the substrate support member.

### BRIEF DESCRIPTION OF DRAWINGS

FIG. 1(a) is a plan view of a wafer holder according to a first embodiment;

FIG. 1(b) is a sectional view along the line indicated by the arrows b-b in FIG. 1(a);

FIG. 2 is a schematic configuration diagram of a wafer inspection apparatus;

FIG. 3 is a plan view showing a transport unit of the inspection apparatus;

FIG. 4(a) is a plan view of a wafer holding device;

FIG. 4(b) is a sectional view along the line indicated by the arrows b-b in FIG. 4(a);

FIG. 5 is a flowchart showing a wafer inspection method;

FIG. 6(a) is an enlarged view of a wafer when observed from above;

FIG. 6(b) is an enlarged sectional view of the wafer;

FIG. 7(a) is an enlarged sectional view of a wafer with the holes swelling out in the middle parts;

FIG. 7(b) is an enlarged sectional view of a wafer with the holes tapering off in the deep parts;

FIG. 8 is a plan view showing a first modification of the wafer holder according to the first embodiment;

FIG. 9 is a plan view showing a second modification of the wafer holder according to the first embodiment;

FIG. 10 is a sectional side view showing a third modification of the wafer holder according to the first embodiment;

FIG. 11(a) is a plan view of a wafer holder according to a second embodiment;

FIG. 11(b) is a sectional view along the line indicated by the arrows b-b in FIG. 11(a);

FIG. 12 is a plan view showing a modification of the wafer holder according to the second embodiment;

FIG. 13(a) is a plan view of a wafer holder according to a third embodiment;

FIG. 13(b) is a sectional view along the line indicated by the arrows b-b in FIG. 13(a);

FIG. 14 is a plan view of a wafer holder according to a fourth embodiment;

FIG. 15 is a sectional side view of the wafer holder according to the fourth embodiment;

FIG. 16 is a sectional side view showing a modification of support portions;

FIG. 17 is a flowchart showing a method for manufacturing a semiconductor device;

FIG. 18(a) is a plan view showing an example of a conventional wafer holder; and

FIG. 18(b) is a sectional side view showing the example of the conventional wafer holder.

### DESCRIPTION OF EMBODIMENTS

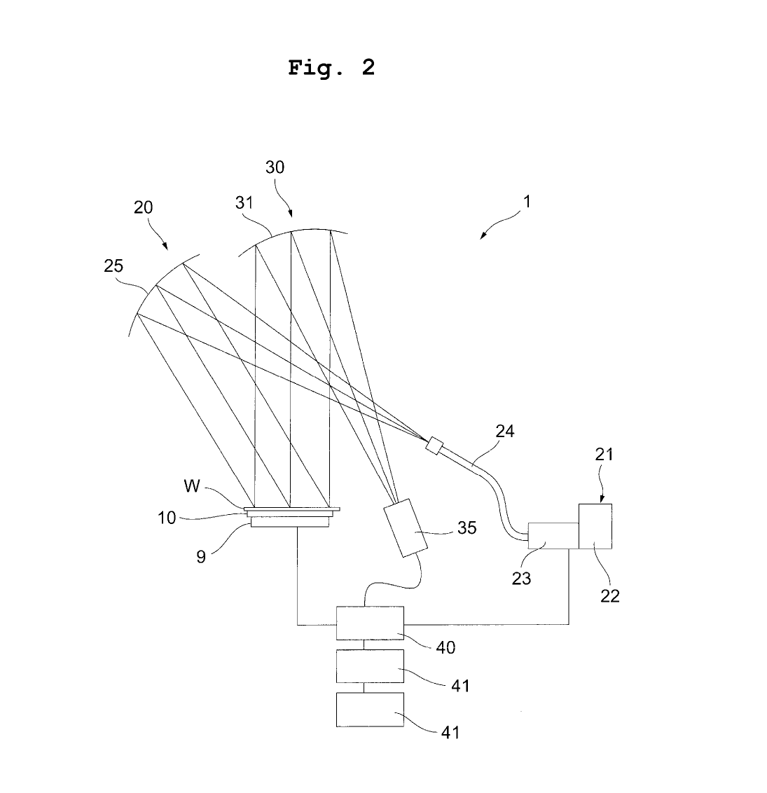

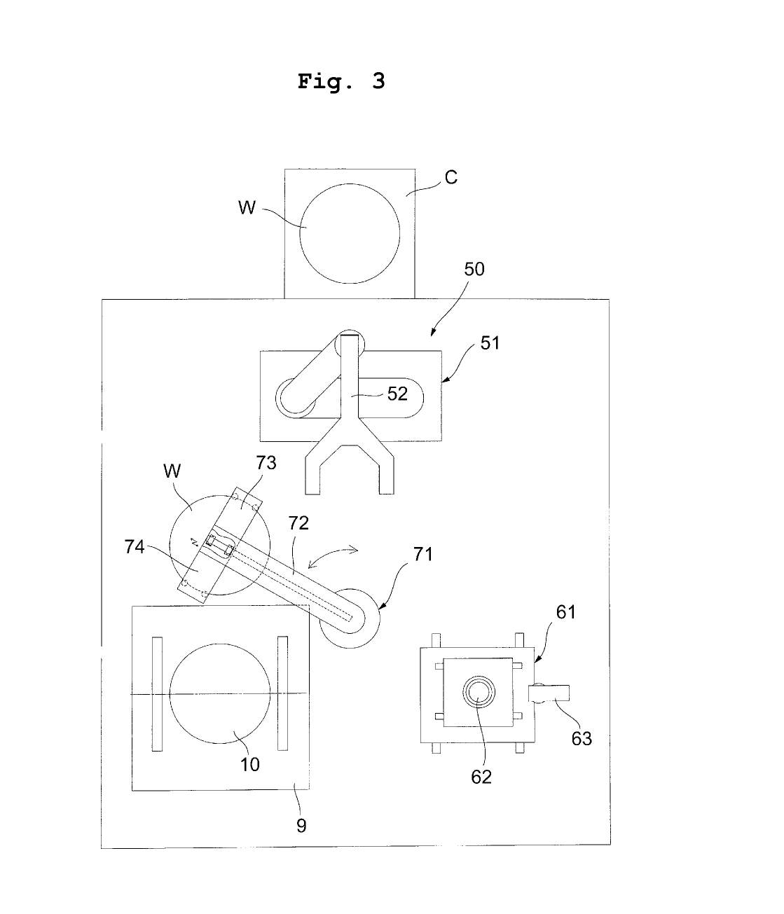

Hereinbelow, referring to the accompanying drawings, explanations will be given about a few embodiments of the present invention. FIG. 2 shows an inspection apparatus of a first embodiment, and this apparatus inspects, at one time, the entire surface of a wafer W which is a silicon substrate (the whole of an aftermentioned observation area T1). The inspection apparatus 1 of the first embodiment includes a wafer holder 10 supporting the approximately circular-disk-like wafer W, and the wafer W transported there by a transport system 50 shown in FIG. 3 is placed on the wafer holder 10 and held fixedly through vacuum suction. By using a tilt mechanism 9 provided on the wafer holder 10, it is possible to tilt the wafer W held on the wafer holder 10 around an axis passing through the surface of the wafer W. That is, it is possible to rotate the wafer W held on the wafer holder 10 around the axis passing through the surface of the wafer W, i.e., around an axis vertical to an incidence plane of illumination light. By virtue of this, the incidence angle of the illumination light becomes adjustable.

The inspection apparatus 1 is configured to further include an illumination system 20 which irradiates the surface of the wafer W held on wafer holder 10 with the illumination light as parallel light, a light receiving system 30 which condenses or focuses the light from the wafer W when receiving the irradiation of the illumination light, an imaging section 35 which takes an image of the wafer W by receiving the light condensed by the light receiving system 30, a control section 40 which carries out operation control for the device, an image processing section 41 which carries out image processing and the like, and a display section 42 which carries out image display. The illumination system 20 is configured to have an illumination unit 21 which emits the illumination light, and an illumination-side concave mirror 25 which reflects the illumination light emitted from the illumination unit 21 toward the surface of the wafer W. The illumination unit 21 is configured to have a light source 22 such as a metal halide lamp, mercury lamp or the like, a dimmer 23 which extracts the light having a predetermined wavelength among the light from the light source 22 and which adjusts the intensity of the extracted light, and a light guiding fiber 24 which guides the light from the dimmer 23 as the illumination light to the illumination-side concave mirror 25.

Then, the light from the light source 22 passes through the dimmer 23, and the illumination light having the predetermined wavelength with a predetermined intensity emits from the light guiding fiber 24 toward the illumination-side concave mirror 25 to become divergent light. Because the emitting portion of the light guiding fiber 24 is arranged on the focal plane of the illumination-side concave mirror 25, the illumination light emitted from the light guiding fiber 24 to the illumination-side concave mirror 25 is then caused by the illumination-side concave mirror 25 to become parallel (telecentric) light which irradiates the entire surface of the wafer W held by the wafer holder 10. Further, with respect to the wafer W, the incoming or incidence and outgoing angles of the illumination light are adjustable by tilting (inclining) the wafer holder 10 to change the angle of placing the wafer W.

The light receiving system 30 condenses the outgoing light from the wafer W (the diffracted light, the regular reflection light and the like). The light receiving system 30 is composed primarily of a light-receiving-side concave mirror 31 arranged to face the wafer holder 10. The outgoing light condensed by the light-receiving-side concave mirror 31 comes onto the imaging plane of the imaging section 35 to form an image of the wafer W. The imaging section 35 includes unshown objective lens, image sensor and the like to generate an image signal (detection signal) by photoelectrically converting the image of the wafer W formed on the imaging plane of the image sensor, and outputting the generated image signal to the image processing section 41 via the control section 40.

The control section 40 controls the operations of the wafer holder 10 and tilt mechanism 9, the illumination unit 21, the imaging section 35, the transport system 50 (see FIG. 3), and the like, respectively. The image processing section 41 generates an image (digital image) of the wafer W based on the image signal inputted from the imaging section 35. A database (not shown) electrically connected with the image processing section 41 prestores the image data of a nondefective wafer. On generating the image of the wafer W, the image processing section 41 compares the generated image data of the wafer W with the image data of the nondefective wafer stored in the database to inspect whether or not there is any abnormity (defection) in the wafer W. Then, the inspection result from the image processing section 41 and the image of that wafer W are outputted and displayed on the display section 42.

However, while being contained in a wafer carrier C as shown in FIG. 3, the inspection object wafer W is transported from a processing device (an etching device, for example) to an unshown port portion of the inspection apparatus 1 after an inspection object process (an etching process, for example), and then taken out of the wafer carrier C to be further transported onto the wafer holder 10 by the transport system 50 provided in the inspection apparatus 1. As shown in FIG. 3, the transport system 50 includes a first transport device 51, a second transport device 61, and a third transport device 71.

The first transport device 51 is configured to include a robot arm 52 which is capable of chucking (sucking and holding, for example) the back side of the wafer W. The first transport device 51 takes out the wafer W contained in the wafer carrier C to transport the wafer W to the second transport device 61 and, on the other hand, takes in the inspected wafer W transported there by the third transport device 71 to let the wafer carrier C contain the same. The second transport device 61 is configured to include a transport stage 62 which is capable of rotation and parallel movement with the back side of the wafer W being chucked (sucked and held, for example), and an alignment portion 63 which carries out alignment with reference to the pattern or outer edge portion of the wafer W (a notch, an orientation flat or the like). After taking in the wafer W transported there by the first transport device 51 and carrying out the alignment, the second transport device 61 transports the wafer W to the third transport device 71. The second transport device 61 carries out the alignment which is one of the transport functions.

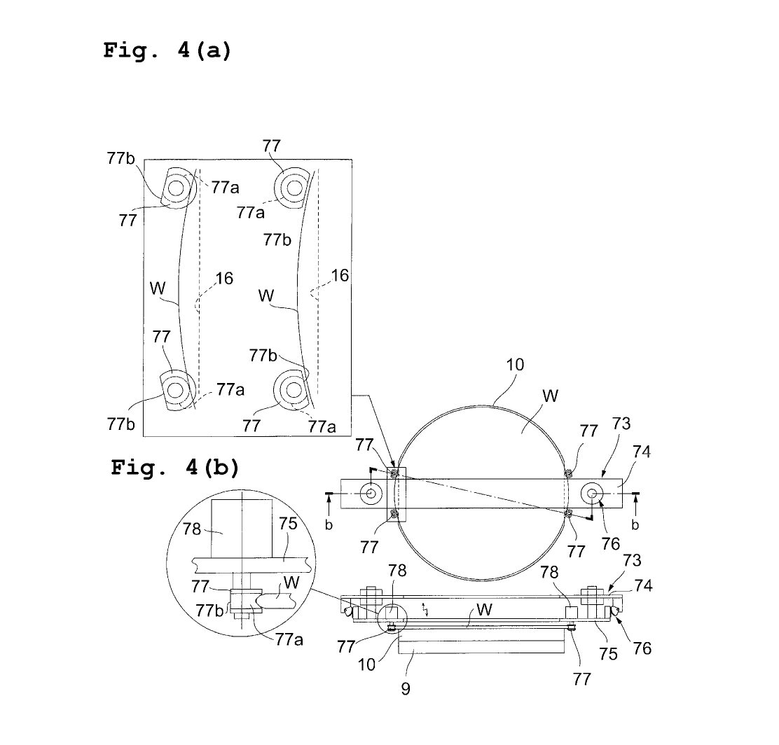

The third transport device 71 is configured to include a transport arm 72 which is capable of swinging within an approximately horizontal plane, and a wafer holding device 73 which is slidably fitted on the transport arm 72 to hold edge portions of the wafer W. The third transport device 71 takes in the wafer W aligned by the second transport device 61 to transport the wafer W onto the wafer holder 10 and, on the other hand, transports the inspected wafer W on the wafer holder 10 to the first transport device 51. (The inspected wafer W is transferred from the third transport device 71 to the first transport device 51. The first transport device 51 takes in the wafer W to let the wafer carrier C contain the wafer W.) As shown in FIGS. 4(a) and 4(b), the wafer holding device 73 is configured to have a plate-like first base member 74 slidably fitted below the transport arm 72, a second base member 75 vertical-movably fitted below the first base member 74, a raising and lowering mechanism 76 which vertically moves (raises and lowers) the second base member 75 relative to the first base member 74, four holding members 77 which are rotatably fitted on the second base member 75 to hold edge portions of the wafer W, and four motors for opening/closing operation 78 which respectively drive the holding members 77 to rotate.

Detailed illustration being omitted, the raising and lowering mechanism 76 includes two guide shafts which extend vertically across the first base member 74 and second base member 75, a rack gear fitted on the second base member 75, and a pinion gear fitted on the first base member 74 to engage the rack gear. Further, the raising and lowering mechanism 76 is not limited to the configuration using a combination of the rack gear and pinion gear, but may adopt various other configurations as necessary. For example, it may either be configured to use a linear actuator such as an air cylinder, electromagnetic solenoid or the like, or be configured to use a ball screw and motor. Further, those configurations are merely exemplifications; hence, the present invention should not be limited thereto.

As shown in the enlarged view of FIG. 4(b), the holding members 77 are each formed into a cylinder in which an engagement groove 77a is formed in its barrel to be engageable with an edge portion of the wafer W. Further, in a lateral portion of each of the holding members 77, a planate cutaway 77b is formed to cut away part of the engagement groove 77a. The four holding members 77 are coupled respectively to the rotary shafts of the four motors for opening/closing operation 78 fitted on the second base member 75, whereby the holding members 77 become rotatable respectively around the rotary shafts of the motors for opening/closing operation 78, as well as capable of vertical movement (up-down movement) relative to the first base member 74. Further, the four holding members 77 are arranged at such intervals as to locate in the vicinity of two edge portions of the wafer W such that, as shown on the right side of the enlarged view of FIG. 4(a), when not holding edge portions of the wafer W, the holding members 77 are each rotationally displaced to a non-holding position to let the cutaways 77b face edge portions of the wafer W. On the other hand, as shown on the left side of the enlarged view of FIG. 4(a), when holding edge portions of the wafer W, the four holding members 77 are each rotationally displaced to a holding position to let the engagement grooves 77a engage the edge portions of the wafer W. In this manner, by rotating the holding members 77, it is possible to either hold edge portions of the wafer W or release the holding of edge portions of the wafer W.

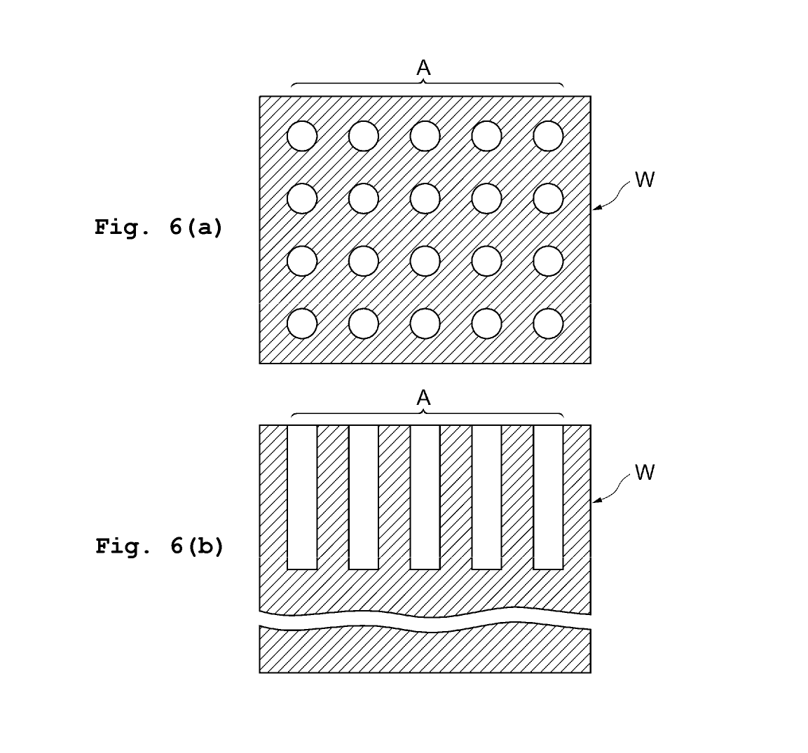

As shown in FIGS. 6(a) and 6(b) for example, a repetitive pattern (hole pattern) is formed in the surface of the wafer W. This pattern A has a structure of forming holes (or vias) regularly arranged in a bare wafer made of silicon (Si). Here, FIG. 6(a) is an enlarged view of part of the wafer W when observed from above, while FIG. 6(b) is an enlarged sectional view of the wafer W. As an example, the hole diameter is 2 μm, the hole pitch or interval is 4 μm, and the hole depth is 20 μm. Further, the wafer W is 725 μm thick, but FIGS. 6(a) and 6(b) illustrate the wafer W without describing its thickness. Further, FIGS. 6(a) and 6(b) show the silicon portion with oblique (hatched) lines and the holes in blank. Further, the abovementioned dimensions, such as the thickness of the wafer W, the pitch, depth and diameter of the holes, etc., are merely exemplifications; hence, the present invention should not be limited thereto.

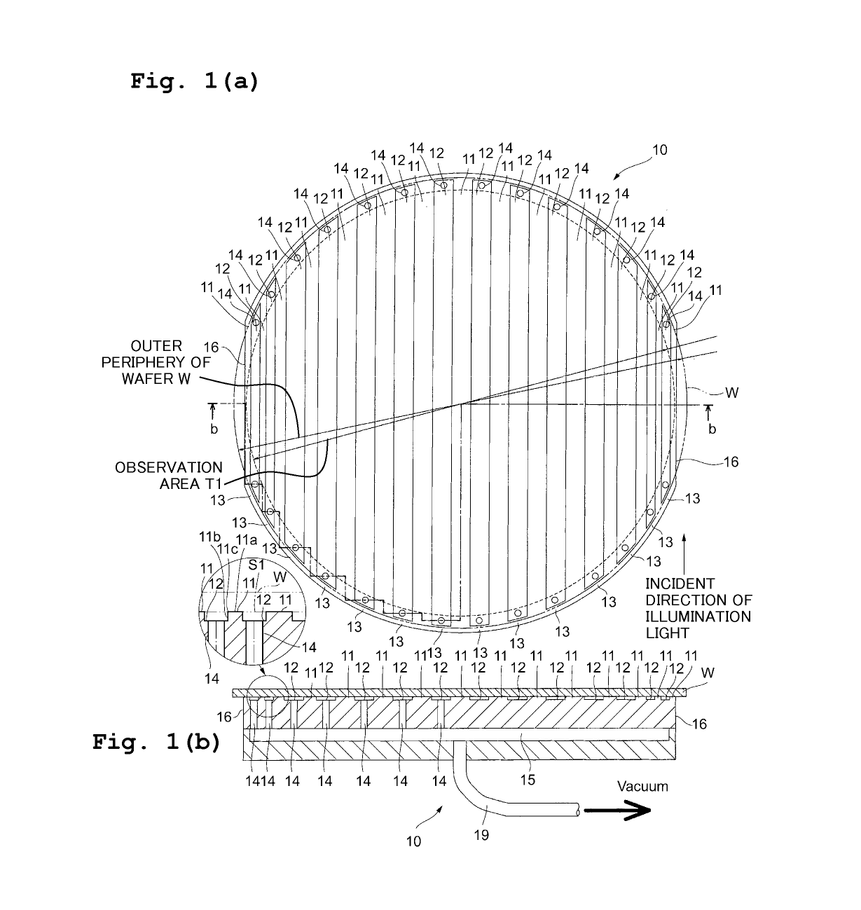

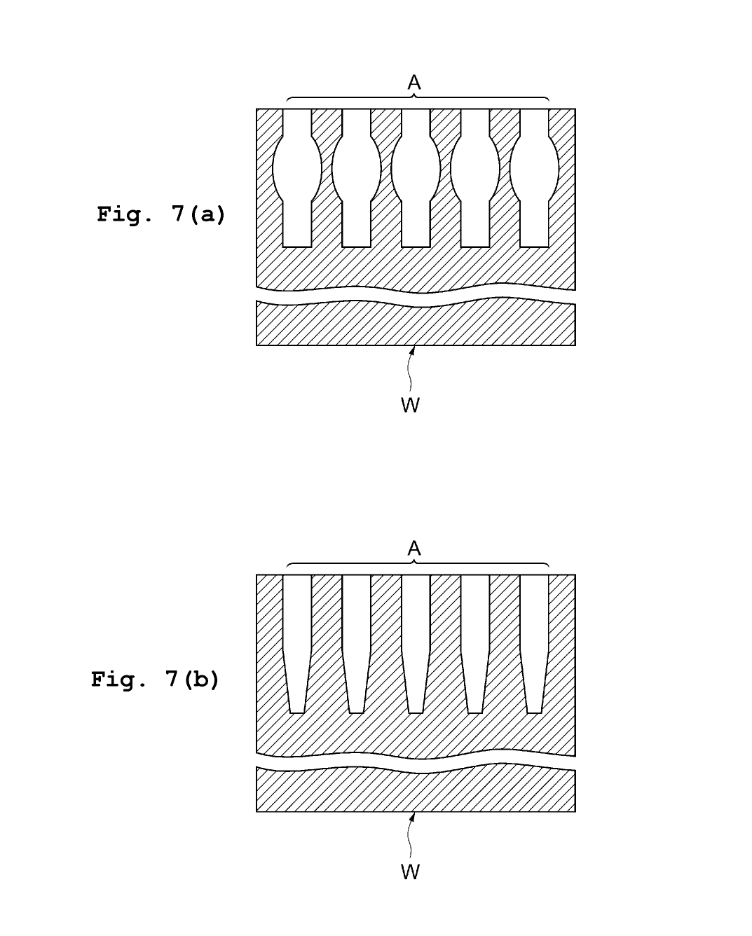

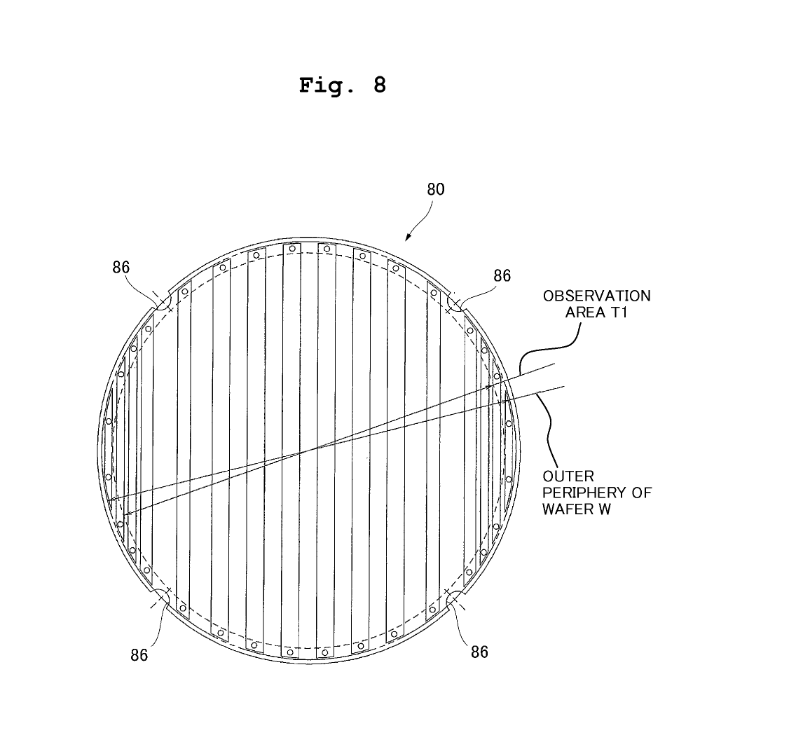

FIGS. 7(a) and 7(b) show examples of abnormally formed holes constituting the pattern A. Here, FIG. 7(a) shows the holes swelling out in the middle parts, while FIG. 7(b) shows the holes tapering off in the deep parts. Since such kinds of shapes will give rise to problems in the succeeding formation process and the function of completed TSVs, it is necessary to find out those holes through inspection. In the first embodiment, the area of the wafer W to be inspected and observed is referred to as the observation area. The observation area T1 of the first embodiment is, as shown in FIG. 1(a), an area inside of the part of the wafer W where an EBR (Edge Bead Removal) process is carried out. Further, the EBR process is a process of removing the residues of resist brought about on some edge portion of the wafer W by peeled-off resist and the like.

Further, the observation area is not limited to the abovementioned area, but can also be an area of the wafer W inside of the inclined part (bevel) of the edge portion of the wafer W. Further, the observation area can also be an area of the wafer W where the pattern A is formed. Further, when there is no observation object in a street or path, then it is also possible to set an observation area to exclude that street from the observation area.

Next, referring to FIG. 1, the wafer holder 10 according to the first embodiment will be explained. Using ceramic or the like, the wafer holder 10 of the first embodiment is formed into an approximately circular disk to fit the shape of the wafer W. The upper-end portion (front-end portion) of the wafer holder 10 is formed with a plurality of protruding support portions 11 to contact with the wafer W when supporting the wafer W, and a plurality of groove portions 12 which are formed between these plurality of support portions 11 and apart from the wafer W.

Each of the support portions 11 is formed into an approximate cuboid to continuously support the wafer W from one end to the other end, and arranged to extend along an incidence plane of the illumination light to the wafer W. Further, the incidence plane of the illumination light is a plane determined by the incident light and incident normal of the illumination light (the normal of the surface of the wafer W or the normal of the surface of the support portions 11 supporting the wafer W). Further, the plurality of support portions 11 are formed to be approximately parallel to each other, as well as formed to let the plurality of groove portions 12 be approximately parallel to each other between the respective support portions 11. Therefore, with each of the support portions 11, there are formed a support surface 11a which is a flat surface to contact with the back side of the wafer W, lateral sides 11b approximately vertical to the support surface 11a, an edge line 11c which is an intersectional line between the support surface 11a and the lateral sides 11b, and the like, all of which extend along the incidence plane of the illumination light.

As described above, the plurality of groove portions 12 are formed to be approximately parallel to each other between the respective support portions 11. With the wafer W being supported by the wafer holder 10, a pressure reduction space S1 is formed with each of the groove portions 12 to be enclosed by the wafer W, and the support portions 11 positioned on both sides of the corresponding groove portion 12. By sucking the air from the pressure reduction spaces S1 formed respectively with the groove portions 12 to reduce the air pressures inside the pressure reduction spaces S1, the wafer W is sucked and held on the wafer holder 10. Further, a plurality of connection portions 13 are each formed to connect the corresponding ends of one adjacent pair of the support portions 11 at a portion of the wafer holder 10 supporting one end or the other end of the wafer W and, by those connection portions 13, both ends of each of the groove portions 12 are closed up to prevent inflow of air or gas into the above pressure reduction spaces S1 from outside.

Further, in the bottoms of the respective groove portions 12, suction holes 14 are formed for sucking air from the respective pressure reduction spaces S1. The suction holes 14 are arranged respectively in the bottoms of the groove portions 12 and in the vicinity of the connection portions 13, i.e., in the portion of the wafer holder 10 supporting the area other than the observation area T1 (the area outside of the observation area T1), and formed to extend downward from the bottoms of the groove portions 12. The lower ends of the suction holes 14 are connected respectively to an internal passage 15 formed inside the wafer holder 10, while the internal passage 15 is connected to an unshown vacuum source (a shared pressure reduction line on a production line, for example) via a vacuum piping 19 fitted below the wafer holder 10.

Further, a black coating capable of absorbing infrared rays is applied to the surface of the upper-end portion (front-end portion) of the wafer holder 10 where the support portions 11, groove portions 12 and the like are formed. Further, without being limited to a black coating, a layer of any suitable infrared absorber may be formed on the upper-end surface of the wafer holder 10 as necessary. For example, as the infrared absorber, it is also possible to apply or attach carbon black, diimmonium salt, aminium salt, or the like, to the surface of the wafer holder 10. Further, black SiC (silicon carbide) may also be used to form the wafer holder 10.

At the left and right sides of the wafer holder 10, a pair of relief portions 16 (also see FIG. 4(a)) are formed to prevent the wafer W from contact with the holding members 77 of the wafer holding device 73 when the third transport device 71 transports the wafer W onto the wafer holder 10. These two relief portions 16 are edges which form cutaways of the approximately circular-disk-like wafer holder 10, and the wafer holder 10 is disposed such that the lateral sides and edge lines (of the wafer holder 10) forming the respective relief portions 16 may extend along the incidence plane of the illumination light.

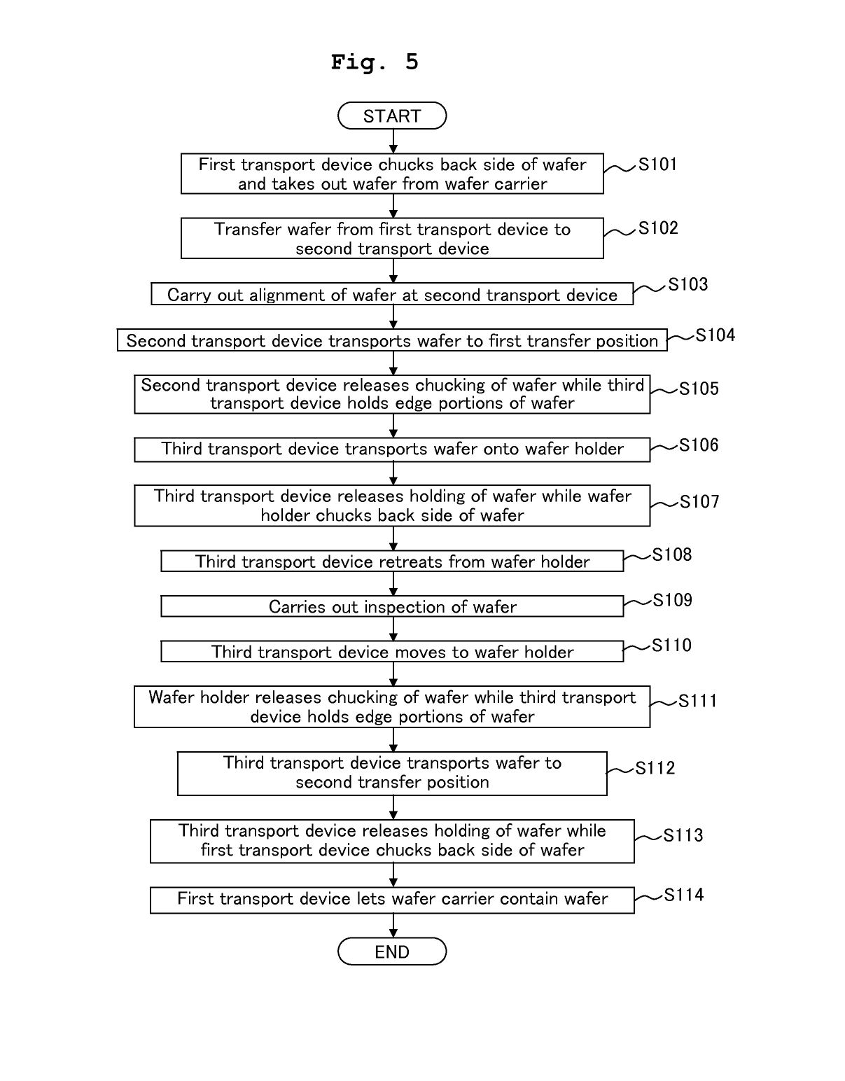

Referring to the flowchart shown in FIG. 5, an explanation will be given about a method for inspecting the wafer W by using the inspection apparatus 1 configured in the above manner. Further, the control section 40 issues commands based on a sequence stored in an unshown storage portion to carry out a series of operations explained below. First, the first transport device 51 chucks the back side of the wafer W contained in the wafer carrier C to take out the wafer W from the wafer carrier C (step S101). Next, the first transport device 51 transports and transfers the wafer W taken out from the wafer carrier C to the second transport device 61 (step S102). At this time, the first transport device 51 (robot arm 52) releases the chucking of the back side of the wafer W, while the second transport device 61 (transport stage 62) chucks the back side of the wafer W.

Next, the second transport device 61 causes the transport stage 62 and alignment portion 63 to carry out the alignment of the wafer W (step S103). At this time, it is configured to acquire positional information of the pattern A formed on the surface of the wafer W, and to carry out the alignment (to detect and store the wafer coordinates based on the notch, orientation flat, alignment mark, or the like) such that the wafer W can be placed on the wafer holder 10 at a predetermined position and in a predetermined direction.

Next, the second transport device 61 transports the aligned wafer W to a predetermined first transfer position to transfer the same to the third transport device 71 (step S104). At this time, at the first transfer position, the second transport device 61 (transport stage 62) releases the chucking of the back side of the wafer W, while the third transport device 71 (wafer holding device 73) holds edge portions of the wafer W (step S105). Further, in order for the wafer holding device 73 to hold the edge portions of the wafer W, after the raising and lowering mechanism 76 and the like adapt the height of the engagement grooves 77a of the four holding members 77 to the height of the edge portions of the wafer W, each of the holding members 77 is rotationally displaced from the aforementioned non-holding position to the holding position.

Next, the third transport device 71 transports the wafer W from the first transfer position onto the wafer holder 10 (step S106). At this time, on the wafer holder 10 maintained in an approximately horizontal state by the tilt mechanism 9, the third transport device 71 (wafer holding device 73) releases the holding of the edge portions of the wafer W, while the wafer holder 10 chucks the back side of the wafer W (step S107).

Further, in order for the wafer holding device 73 to release the holding of the edge portions of the wafer W, each of the holding members 77 is rotationally displaced from the aforementioned holding position to the non-holding position. On the other hand, in order for the wafer holder 10 to chuck the back side of the wafer W, with the back side of the wafer W being in contact with the wafer holder 10, the vacuum source (not shown) is used to suck the air, via the suction holes 14, from the pressure reduction spaces S1 formed respectively with the groove portions 12 of the wafer holder 10. By virtue of this, the pressures inside the pressure reduction spaces S1 are reduced, and thus the wafer W is sucked and held on the wafer holder 10.

In this manner, when the wafer W to be inspected is transported with its surface facing upward onto the wafer holder 10, then the third transport device 71 retreats from the wafer holder 10 to a predetermined retreat position so as not to obstruct the inspection (step S108). After the third transport device 71 retreats from the wafer holder 10, inspection of the wafer W is carried out (step S109).

When the inspection of the wafer W is finished, then the third transport device 71 moves from the predetermined retreat position to the wafer holder 10 (step S110). At this time, on the wafer holder 10, the wafer holder 10 releases the chucking of the back side of the wafer W, while the third transport device 71 (wafer holding device 73) holds edge portions of the wafer W (step S111).

Further, in order for the wafer holder 10 to release the chucking of the back side of the wafer W, after the tilt mechanism 9 restores the wafer holder 10 to an approximately horizontal state, a gas supply device (not shown), switching valve (not shown) and the like are used to supply air or a gas from the suction holes 14 to the aforementioned pressure reduction spaces S1 formed in the wafer holder 10. By virtue of this, the reduced pressures inside the pressure reduction spaces S1 return to the atmospheric pressure, thereby releasing the wafer W from being sucked by the wafer holder 10. On the other hand, in order for the wafer holding device 73 to hold edge portions of the wafer W, after the raising and lowering mechanism 76 and the like adapt the height of the engagement grooves 77a of the four holding members 77 to the height of the edge portions of the wafer W, each of the holding members 77 is rotationally displaced from the aforementioned non-holding position to the holding position.

Next, the third transport device 71 transports the inspected wafer W from the wafer holder 10 to a predetermined second transfer position to transfer the same to the first transport device 51 (step S112). At this time, at the second transfer position, the third transport device 71 (wafer holding device 73) releases the holding of the edge portions of the wafer W, while the first transport device 51 (robot arm 52) chucks the back side of the wafer W (step S113).

Then, the first transport device 51 transports the inspected wafer W from the first transfer position into the wafer carrier C to contain the wafer W (step S114). At this time, the first transport device 51 (robot arm 52) releases the chucking of the back side of the wafer W in the wafer carrier C, and then retreats from the wafer carrier C. This finishes the inspection of the one wafer W which is an inspection object. Further, when the wafer carrier C contains a plurality of wafers W to be inspected, then until all of the wafers W are finished with the inspection, the aforementioned process from step S101 to step S114 is repeated.

Next, the inspection of the wafer W in step S109 will be explained. In order to inspect the wafer W, first, the surface of the wafer W sucked and held by the wafer holder 10 is irradiated with illumination light transmissive for the wafer W (light of the wavelengths from 900 nm to 1100 nm, for example). At this time, the illumination light having a predetermined wavelength (in the range of visible or near-infrared light) is emitted from the illumination unit 21 to the illumination-side concave mirror 25, reflected from the illumination-side concave mirror 25 to become parallel light, and irradiates the entire surface of the wafer W held by the wafer holder 10.

Still at this time, by adjusting the wavelength of the illumination light emitted from the illumination unit 21, and the rotation angle and tilt angle of the wafer W held on the wafer holder 10 (to be referred to hereinbelow as satisfying a diffraction condition), the imaging section 35 can receive the diffracted light from the repetitive pattern A regularly formed at a predetermined pitch to form an image of the wafer W. In particular, the transport stage 62 and alignment portion 63 of the second transport device 61 rotate the wafer W such that the illumination direction on the surface of the wafer W (the direction from the illumination system 20 toward the light receiving system 30) may consist with the repetitive direction of the pattern A, while the tilt mechanism 9 carries out such a setting as to satisfy the following Formula 1 based on Huygens' principle (to tilt the wafer holder 10), where P represents the pitch of the pattern A, λ represents the wavelength of the illumination light irradiating the surface of the wafer W, θ1 represents the incoming angle of the illumination light, and θ2 represents the outgoing angle of the nth-order diffracted light.

P=n×λ/{sin(θ1)−sin(θ2)} [Formula 1]

Next, it is configured to detect the diffracted light from the wafer W irradiated with the illumination light. The diffracted light arising from the repetitive pattern A of the wafer W is condensed by the light-receiving-side concave mirror 31, and then comes onto the imaging plane of the imaging section 35 to form an image of the wafer W (an image formed from the diffracted light). At this time, the image sensor of the imaging section 35 generates an image signal by photoelectrically converting the image of the wafer W formed on the imaging plane, and outputs the generated image signal to the image processing section 41 via the control section 40.

Then, the wafer W is inspected by using information of the detected diffracted light (the diffracted light intensity, for example). At this time, the image processing section 41 generates an image of the wafer W (a digital image) based on the image signal inputted from the imaging section 35. Further, having generated the image of the wafer W (the digital image), the image processing section 41 compares the generated image data of the wafer W with the image data of the nondefective wafer stored in the database (not shown) to inspect whether or not there is any abnormity (defection) in the wafer W. Further, the inspection of the wafer W is carried out according to each chip region, and it is determined to be abnormal when the difference between the signal intensity (brightness value) of the inspection object wafer W and the signal intensity (brightness value) of the nondefective wafer is greater than a predetermined threshold value. On the other hand, it is determined to be normal when the difference between the signal intensities (brightness values) is smaller than the threshold value. Then, the inspection result from the image processing section 41 and the image of that wafer W are outputted and displayed on the display section 42.

When the inspection apparatus 1 of the first embodiment is used to obtain an image based on the diffracted light from the entire surface of the wafer W, then the obtained image has a brightness in accordance with the intensity of the diffracted light (to be referred to hereinbelow as a diffraction image). The diffracted light intensity changes according to the distribution of diffraction efficiency. Thus, when the regularly formed pattern A is uniformly laid out, then localized change in diffraction efficiency does not occur. On the contrary, when the pattern A changes in shape in some region, then the diffraction efficiency also changes in that region. As a result, the corresponding region of the diffraction image changes in brightness, and thereby it is possible to detect the change of the pattern in the corresponding region. Further, the change of the pattern refers to the change of the pattern A in line width (hole diameter) or cross-sectional shape.

The distance or length on the wafer W corresponding to one pixel (pixel size) of the diffraction image obtained by the imaging section 35 is, for example, 300 μm, which is, generally, much greater than the dimension of the pattern A or the repetitive pitch. However, the brightness of each pixel in the diffraction image corresponds to an average intensity of the diffracted light from the pattern of the corresponding region on the wafer W. When the pattern A of the wafer W is not normally formed due to some problems in the exposure device and the like for forming the pattern, then it is conceivable that the entire pattern of the region occupying a certain area deforms in the same manner. Therefore, even though the pixel size is greater than the dimension of the pattern A or the repetitive pitch, it is still possible to detect abnormity (defection) of the corresponding region.

For example, when it is set to emit a light (illumination light) of the wavelength 546 nm (e-ray) from the illumination unit 21 based on a command from the control section 40, and when the diffraction condition is satisfied, then the imaging section 35 can obtain a diffraction image. From this diffraction image, as described above, it is possible to detect abnormity (defection) in the pattern A. However, because the light of the wavelength 546 nm is not transmissive through silicon, the detectable abnormities are only those in the vicinity of the surface of the wafer W. That is, the detectable abnormities are abnormity in the hole diameter near the surface of the wafer W, abnormity in the cross-sectional shape of the holes near the surface of the wafer W, etc.

When it is set to emit a light including infrared of the wavelength 700 nm or longer, for example, a light (illumination light) of the wavelength 1100 nm, from the illumination unit 21 based on a command from the control section 40, and when the diffraction condition is satisfied, then a diffraction image can be obtained in the same manner. On this occasion, because the light of the wavelength 1100 nm is transmissive through the silicon substrate (thickness 725 μm) used in the first embodiment, it is possible to detect abnormities (defections) even in deep parts of the holes. The reason is that although the light of the wavelength 1100 nm is transmitted through the silicon, diffracted light (diffraction phenomenon) still occurs in the boundary (interface) between the part of silicon and the part of holes of the wafer W.

When the wafer W formed with TSVs is inspected by irradiating, with infrared light, the wafer W held by a conventional wafer holder (of which material is ceramic or aluminum alloy), then part of the irradiated infrared light is transmitted to the opposite side of the wafer W. Therefore, other than the diffracted light from the inspection object wafer, reflected and scattered light is also received from the edges and the like of the support portions (suction grooves) of the wafer holder, and becomes noise in the image of the wafer W, thereby being liable to obstruct the inspection.

In contrast to this, in the wafer holder 10 of the first embodiment, each of the protruding support portions 11 is configured to extend continuously from the part supporting one end of the wafer W to the part supporting the other end, without any line or plane orthogonal to the incidence plane of the illumination light to the wafer W in the portion of the wafer holder 10 supporting the aforementioned observation area T1. In other words, in the portion of the wafer holder 10 supporting the aforementioned observation area T1, each of the protruding support portions 11 (and groove portions 12) is formed to intersect the incidence plane of the illumination light at an acute angle or obtuse angle. For example, in an area overlapping the observation area T1 in planar view, the lateral sides 11b and edge lines 11c of the support portions 11 are formed to be not orthogonal to the incidence plane of the illumination light. Further, it is desirable to form an angle not exceeding 45 degrees (including zero degrees) between each of the protruding support portions 11 (and groove portions 12) and the incidence plane of the illumination light. Further, the plane orthogonal to the incidence plane of the illumination light refers to such a plane that when it is flat then its perpendicular is parallel to the incidence plane, but when it is curved then its normal is parallel to the incidence plane. By virtue of this, even when any reflected and scattered infrared light arises from the edges (the parts of the edge lines 11c) of the protruding support portions 11, because the perpendicular to the edges does not extend parallel to the incidence plane of the illumination light (that is, toward the light receiving system 30), most of the reflected and scattered light arising from the edges proceeds in a different direction from the propagation direction of the diffracted light arising from the pattern A (that is, the light-receiving direction of the light receiving system 30). Therefore, because the reflected and scattered light arising from the edges of the protruding support portions 11 becomes less likely to reach the light receiving system 30, in the observation area T1 of the wafer W, it is possible to prevent detection of the reflected and scattered light arising from the wafer holder 10. Further, because it is possible to prevent detection of the reflected and scattered light arising from the wafer holder 10, based on the image of the wafer W with little noise, it becomes possible to inspect whether or not there is any abnormity (defection) in the wafer W, thereby allowing the inspection precision to be improved.

Further, the relief portions 16 formed with the wafer holder 10 are also arranged to not have any lines or planes orthogonal to the incidence plane of the illumination light. Likewise, in this case, too, even when any reflected and scattered infrared light arises from the edges of the relief portions 16, because the perpendicular to the edges does not extend parallel to the incidence plane of the illumination light (that is, toward the light receiving system 30), most of the reflected and scattered light arising from the edges of the relief portions 16 proceeds in a different direction from the propagation direction of the diffracted light arising from the pattern A (that is, the light-receiving direction of the light receiving system 30). Therefore, because the reflected and scattered light arising from the edges of the relief portions 16 becomes less likely to reach the light receiving system 30, in the observation area T1 of the wafer W, it is possible to more reliably prevent detection of the reflected and scattered light arising from the wafer holder 10, thereby allowing the inspection precision to be improved more.

Further, the support portions 11 are each formed into an approximate cuboid, and extend along the incidence plane of the illumination light. Therefore, the lateral sides 11b and edge lines 11c of the support portions 11 are parallel to but not orthogonal to the incidence plane of the illumination light. By virtue of this, it is possible to more reliably prevent detection of the reflected and scattered light arising from the wafer holder 10, thereby allowing the inspection precision to be improved more.

Further, the tilt mechanism 9 is provided to tilt (rotate) the wafer holder 10 around an axis vertical to the incidence plane of illumination light, and thus it is possible to change the incident angle and the like of the illumination light to the wafer W. Therefore, it is possible to detect the desired diffracted light from the wafer W without detecting the reflected and scattered light arising from the wafer holder 10, thereby allowing the inspection precision to be improved more.

Further, when it is configured to use the illumination light including infrared of the wavelength 700 nm or longer, then it is possible to use an ordinary image sensor to detect the light from the wafer W (to take an image of the wafer W), whereby the inspection can be carried out with a simple and convenient configuration. Further, because the sensitivity of the image sensor to near-infrared may decrease so as to lower the signal-noise ratio, a cooled image sensor can be used as necessary to raise the signal-noise ratio.

Further, the wafer holder 10 of the first embodiment is configured to suck and hold the wafer W by sucking the air from the pressure reduction spaces S1 formed by the wafer W and support portions 11 to reduce the pressures inside the pressure reduction spaces S1, and the suction holes 14 through which the air is sucked are provided in the portion of the wafer holder 10 supporting the other area than the observation area T1 (in the groove portions 12 and in the vicinity of the connection portions 13). In this manner, by arranging the suction holes 14 outside of the observation area T1, it is possible to suck and hold the wafer W without detecting the reflected and scattered light arising from the edges and the like of the suction holes 14, in the observation area T1.

Further, the plurality of connection portions 13 are each formed to connect the corresponding ends of one adjacent pair of the support portions 11 in a portion of the wafer holder 10 supporting one end or the other end of the wafer W and, by those connection portions 13, both ends of each of the groove portions 12 are closed up to prevent inflow of air or gas into the aforementioned pressure reduction spaces S1 from outside. By virtue of this, by arranging the connection portions 13 outside of the portion of the wafer holder 10 supporting the observation area T1, it is possible to more reliably suck and hold the wafer W without detecting the reflected and scattered light arising from the edges and the like of the connection portions 13, in the observation area T1.

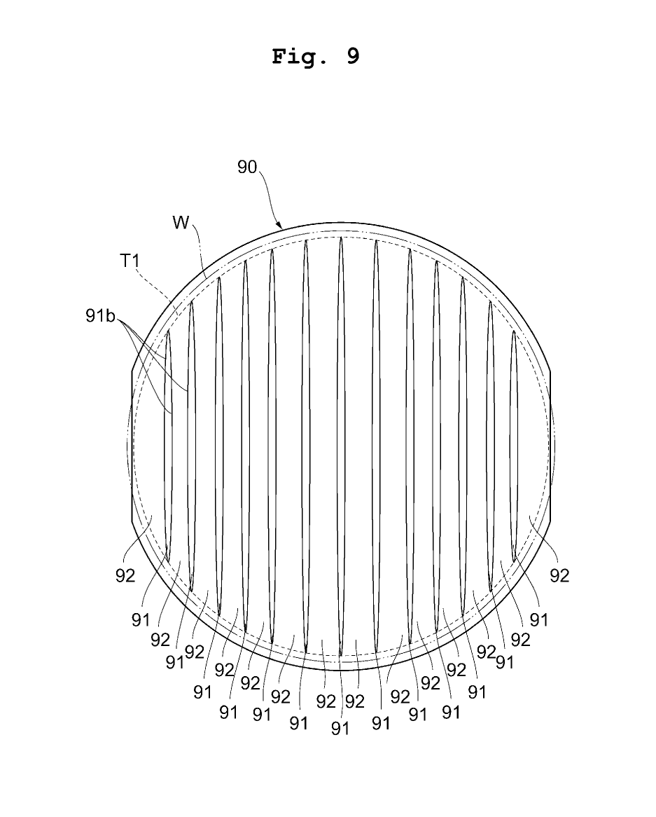

Further, in the first embodiment described above, the two relief portions 16 formed at lateral sides of the wafer holder 10 are configured to extend respectively along the incidence plane of the illumination light. However, they are not limited to this configuration. As shown in FIG. 8 for example, four relief portions 86 may alternatively be formed at lateral sides of a wafer holder 80 at regular intervals (90° intervals). Because each of the relief portions 86 shown in FIG. 8 has an arc-like cutaway, part of the arc may become a line or plane orthogonal to the incidence plane of the illumination light. However, there is no obstruction because the relief portions 86 are all located out of the observation area T1. Being configured in this manner, it is possible to arrange the four holding members 77 of the wafer holding device 73 at regular intervals (90° intervals) along the edge of the wafer W, so as to enable the wafer holding device 73 to stably hold edge portions of the wafer W. Further, the wafer holder 80 shown in FIG. 8 has the same configuration as the wafer holder 10 shown in FIGS. 1(a) and 1(b) except for the relief portions 86, and therefore reference numerals are omitted except for the relief portions 86. Further, each of the relief portions 86 is formed with a curved surface to fit the shape of the holding members 77, and positioned outside of the portion of the wafer holder 10 supporting the observation area T1.

Further, in the first embodiment described above, the support portions 11 are each formed into an approximate cuboid to extend along the incidence plane of the illumination light, and the lateral sides 11b of the support portions 11 are flat surfaces approximately vertical to the support surfaces 11a respectively. However, the support portions 11 are not limited to this configuration. As shown in FIG. 9 for example, lateral sides 91b, 91b at two sides of each support portion 91 may be formed into curved surfaces approximately vertical to the support surface, and be connected at an approximately acute angle with each other at both ends of each support portion 91. In such configuration, because there is no line or plane orthogonal to the incidence plane of the illumination light in the portion of a wafer holder 90 supporting the observation area T1 of the wafer W, it is possible to prevent detection of the reflected and scattered light arising from the wafer holder 90, thereby allowing the inspection precision to be improved. Further, in the wafer holder 90 shown in FIG. 9, connection portions (not shown) may also be provided to connect corresponding ends of the support portions 91, so as to close up both ends of each groove portion 92 on the outside of the portion of the wafer holder 90 supporting the observation area T1. By virtue of this, because no air or gas flows from outside into the pressure reduction spaces described in the aforementioned first embodiment, it is possible to more reliably suck and hold the wafer W. Further, suction holes (not shown) may also be formed in the groove portions 92, respectively, on the outside of the portion of the wafer holder 90 supporting the observation area T1.

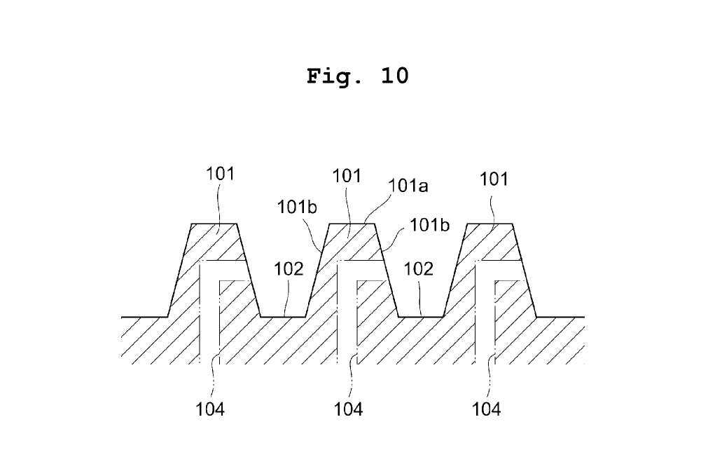

Further, as shown in FIG. 10, each support portion 101 may be formed into a tapered shape such that lateral sides 101b of each support portion 101 are inclined obliquely to a support surface 101a. In such configuration, it is also possible to obtain the same effect as in the case described in the aforementioned first embodiment. Further, in this case as shown by the two-dot chain lines in FIG. 10, without being limited to the bottoms of groove portions 102, suction holes 104 may also be formed in the lateral sides 101b of the support portions 101.

Further, in the first embodiment described above, the suction holes 14 are provided to suck the air from the pressure reduction spaces S1 formed by the wafer W and support portions 11. However, without being limited to this configuration, the wafer holder may also be formed of a porous material (for example, a porous metal, porous ceramics, etc.), and the vacuum source (not shown) may be used to suck the air from the pressure reduction spaces formed by the wafer W and support portions via tiny air holes or pores formed in the wafer holder. In such configuration, it is also possible to reduce the pressures inside the pressure reduction spaces, so as to suck and hold the wafer W on the wafer holder 10.

Further, in the first embodiment described above, the plurality of connection portions 13 are each formed to connect the corresponding ends of one adjacent pair of the support portions 11 at a portion of the wafer holder 10 supporting one end or the other end of the wafer W and, by those connection portions 13, both ends of each of the groove portions 12 are closed up to prevent inflow of air or gas into the aforementioned pressure reduction spaces S1 from outside. However, the present invention is not limited to such configuration. For example, between the corresponding ends of each adjacent pair of the support portions 11, a pressure reduction auxiliary portion may be provided to close up part of both ends of the corresponding groove portion 12, so as to prevent inflow of air or gas into the pressure reduction spaces S1 from outside.

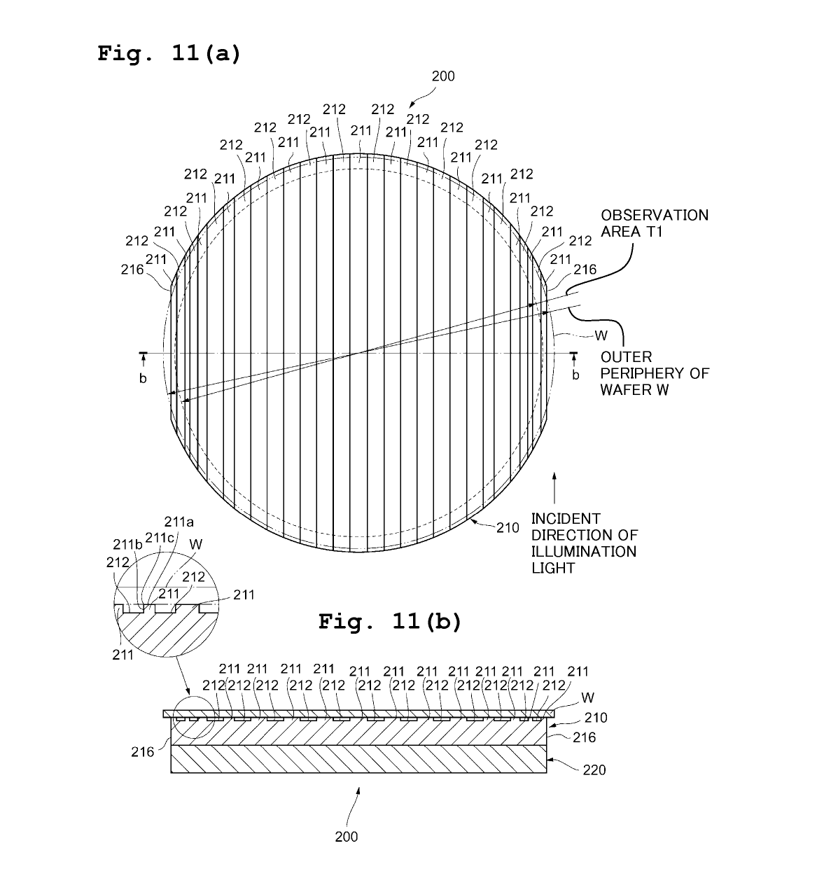

Next, referring to FIGS. 11(a) and 11(b), a second embodiment of the inspection apparatus will be explained. The inspection apparatus of the second embodiment has the same configuration as the inspection apparatus 1 of the first embodiment except for the wafer holder. Therefore, the same reference numeral is assigned to each of the other portions as in the first embodiment while detailed explanation will be omitted. A wafer holder 200 of the second embodiment primarily includes a planate electrode (not shown), and a pair of insulation members, i.e., a dielectric layer 210 and a supportive layer 220, oppositely arranged to sandwich the electrode, and is configured to use electrostatic force to suck and hold the wafer W by applying a predetermined voltage to the electrode with the wafer W being placed on the dielectric layer 210.

The dielectric layer 210 and supportive layer 220 are formed into an approximately circular disk to fit the shape of the wafer W by using an insulation material such as ceramic or the like. On the upper-end portion (front-end portion) of the dielectric layer 210, there are formed a plurality of protruding support portions 211 to contact with the wafer W when supporting the wafer W, and a plurality of groove portions 212 formed between the plurality of support portions 211 and apart from the wafer W.

Each of the support portions 211 is formed into an approximate cuboid to continuously support the wafer W from one end to the other end, and arranged to extend along an incidence plane of the illumination light to the wafer W. Further, the plurality of support portions 211 are formed to be approximately parallel to each other, as well as formed to let the plurality of groove portions 212 be approximately parallel to each other between the respective support portions 211. Therefore, with each of the support portions 211, there are formed a support surface 211a which is a flat surface to contact with the back side of the wafer W, lateral sides 211b approximately vertical to the support surface 211a, an edge line 211c which is an intersectional line between the support surface 211a and the lateral sides 211b, and the like, all of which extend along the incidence plane of the illumination light.

Further, a black coating capable of absorbing infrared rays is applied to the surface of the upper-end portion (front-end portion) of the dielectric layer 210 where the support portions 211, groove portions 212 and the like are formed. Further, without being limited to a black coating, it is possible to form a layer of any suitable infrared absorber on the upper-end surface of the dielectric layer 210. For example, as the infrared absorber, it is also possible to apply or attach carbon black, diimmonium salt, aminium salt, or the like, to the surface of the dielectric layer 210. Further, black SiC (silicon carbide) may also be used to form the dielectric layer 210.

At the left and right sides of the dielectric layer 210 (and supportive layer 220), a pair of relief portions 216 are formed to prevent the wafer W from contact with the holding members 77 of the wafer holding device 73 when the third transport device 71 transports the wafer W onto the wafer holder 200 (the dielectric layer 210). These two relief portions 216, 216 are edges which form cutaways of the approximately circular-disk-like dielectric layer 210 (and supportive layer 220), and the wafer holder 200 is disposed such that the lateral sides and edge lines (of the dielectric layer 210 and supportive layer 220) forming the respective relief portions 216 may extend along the incidence plane of the illumination light.

With the wafer holder 200 of the second embodiment configured in the above manner, in order to chuck the back side of the wafer W, the predetermined voltage is applied to the electrode (not shown) with the back side of the wafer W in contact with the dielectric layer 210 (support portions 211). By virtue of this, the wafer W is sucked and held on the wafer holder 200 by using electrostatic force. On the other hand, in order to release the chucking of the back side of the wafer W from the wafer holder 200, it is only necessary to turn off the power to the electrode after the tilt mechanism 9 restores the wafer holder 200 to an approximately horizontal state.

In the wafer holder 200 of the second embodiment, each of the protruding support portions 211 is configured to extend continuously from the part supporting one end of the wafer W to the part supporting the other end, without any line or plane orthogonal to the incidence plane of the illumination light to the wafer W in the portion of the wafer holder 200 supporting the observation area T1 of the wafer W. In other words, in the portion of the wafer holder 200 supporting the aforementioned observation area T1, each of the protruding support portions 211 (and groove portions 212) is formed to intersect the incidence plane of the illumination light at an acute angle or obtuse angle. For example, the lateral sides 211b and edge lines 211c of the support portions 211 are formed to be not orthogonal to the incidence plane of the illumination light. Therefore, in the same manner as in the first embodiment, it is possible to prevent detection of the reflected and scattered light arising from the wafer holder 200, thereby allowing the inspection precision to be improved.

Further, according to the second embodiment, in the same manner as in the first embodiment, because the wafer holder 200 is formed with the relief portions 216, it is possible to more reliably prevent detection of the reflected and scattered light arising from the wafer holder 200, thereby allowing the inspection precision to be improved more. Further, still in the same manner as in the first embodiment, because the support portions 211 are each formed into an approximate cuboid to extend along the incidence plane of the illumination light, it is possible to more reliably prevent detection of the reflected and scattered light arising from the wafer holder 200, thereby allowing the inspection precision to be improved more.

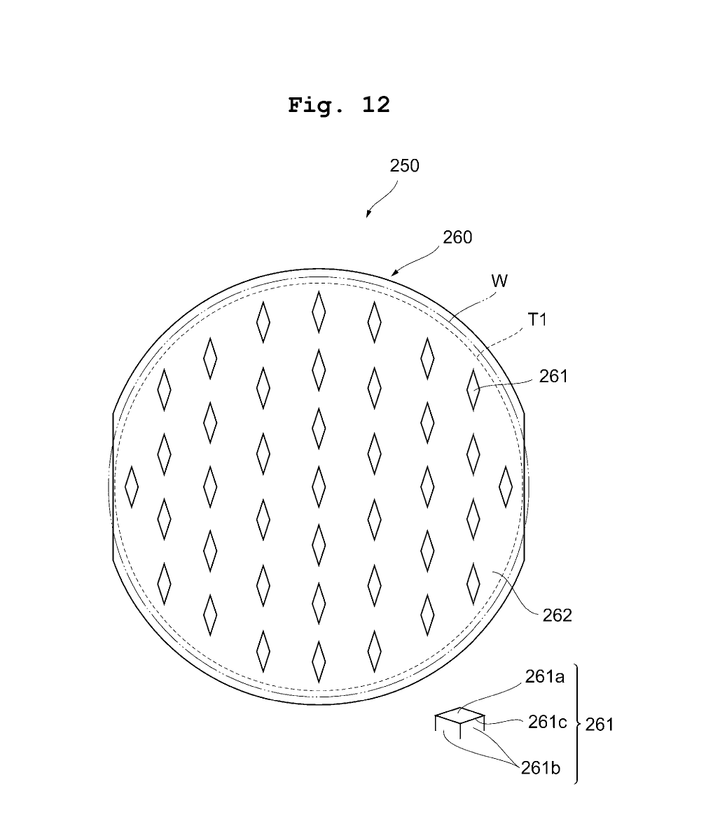

Further, in the second embodiment described above, each of the support portions 211 is formed into an approximate cuboid to continuously support the wafer W from one end to the other end. However, without being limited to this configuration, as shown in FIG. 12 for example, each support portion 261 may be formed into a rhombic protrusion. Further, on a dielectric layer 260 of a wafer holder 250 shown in FIG. 12, there are formed the plurality of support portions 261 to contact with the wafer W when supporting the wafer W, and a separate portion 262 apart from the wafer W. Each of the support portions 261 is formed into the rhombic protrusion to partially support the wafer W, and arranged such that the long diagonal of a rhombic support surface 261a may extend along the incidence plane of the illumination light to the wafer W. Further, the plurality of support portions 211, 211, . . . are arranged to align in a plurality of rows parallel to the incidence plane of the illumination light. Therefore, with each of the support portions 261, there are formed lateral sides 261b approximately vertical to the rhombic support surface 261a, an edge line 261c which is an intersectional line between the support surface 261a and the lateral sides 261b, and the like, all of which extend obliquely (not vertically) to the incidence plane of the illumination light. Further, when a chamfering process or the like is carried out to prevent burrs on the vertexes of the edge lines 261c, then it is possible to form planes or lines orthogonal to the incidence plane of the illumination light. Therefore, it is desirable to arrange the vertexes of the edge lines 261c into aftermentioned streets Ws.

By virtue of this, even when any reflected and scattered infrared light arises from the edges (the parts of the edge lines 211c) of the protruding support portions 261, because the perpendicular to the edges does not extend parallel to the incidence plane of the illumination light (that is, toward the light receiving system 30), most of the reflected and scattered light arising from the edges proceeds in a different direction from the propagation direction of the diffracted light arising from the pattern A (that is, the light-receiving direction of the light receiving system 30), thereby becoming less likely to reach the light receiving system 30. In this manner, in the portion of the wafer holder 250 supporting the observation area T1 of the wafer W, the wafer holder 250 shown in FIG. 12 is configured not to have any lines or planes orthogonal to the incidence plane of the illumination light to the wafer W (the lateral sides 261b and edge line 261c of each of the support portions 261 are not orthogonal to the incidence plane of the illumination light). Therefore, it is possible to obtain the same effect as the aforementioned second embodiment.

Further, in the second embodiment described above, like the first embodiment, it is also possible either to form four relief portions at lateral sides of the wafer holder at regular intervals (90° intervals), or to form each of the support portions into a tapered shape.

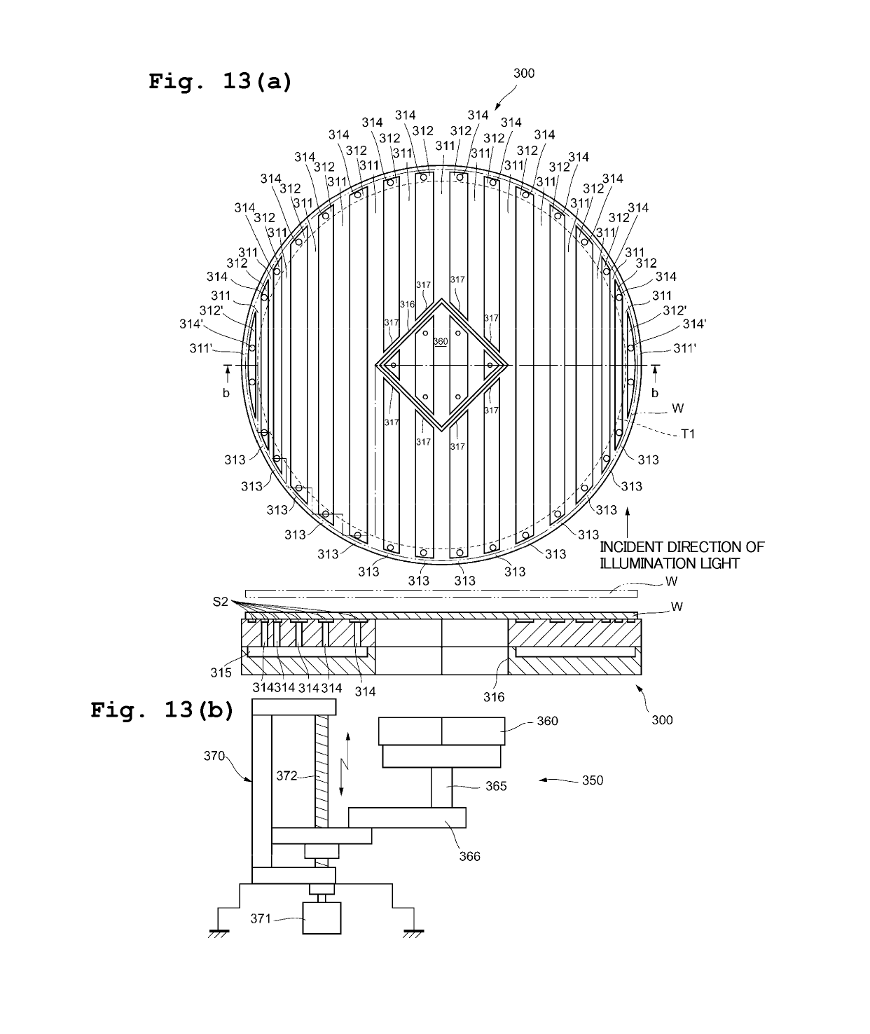

Next, referring to FIGS. 13(a) and 13(b), a third embodiment of the inspection apparatus will be explained. The inspection apparatus of the third embodiment has the same configuration as the inspection apparatus 1 of the first embodiment except for the wafer holder. Therefore, the same reference numeral is assigned to each of the other portions as in the first embodiment while detailed explanation will be omitted. Using ceramic or the like, a wafer holder 300 of the third embodiment is formed into an approximately circular disk to fit the shape of the wafer W. The upper-end portion (front-end portion) of the wafer holder 300 is formed with a plurality of protruding support portions 311 to contact with the wafer W when supporting the wafer W, and a plurality of groove portions 312 which are formed between these plurality of support portions 311 and apart from the wafer W.

In the same manner as in the first embodiment, each of the support portions 311 is formed into an approximate cuboid to continuously support the wafer W from one end to the other end, and arranged to extend along an incidence plane of the illumination light to the wafer W. Further, still in the same manner, the plurality of support portions 311 in the portion supporting the observation area T1 are formed to be approximately parallel to each other, as well as formed to let the plurality of groove portions 312 be approximately parallel to each other between the respective support portions 311.

Then, with the wafer W being supported by the wafer holder 300, a pressure reduction space S2 is formed with each of the groove portions 312 to be enclosed by the wafer W, and the support portions 311 positioned on both sides of the corresponding groove portion 312. By sucking the air from the pressure reduction spaces S2 formed respectively with the groove portions 312 to reduce the pressures inside the pressure reduction spaces S2, the wafer W is sucked and held on the wafer holder 300. Further, a plurality of connection portions 313 are each formed to connect the corresponding ends of one adjacent pair of the support portions 311 at a portion of the wafer holder 300 supporting one end or the other end of the wafer W and, by those connection portions 313, both ends of each of the groove portions 312 are closed up to prevent inflow of air or gas into the above pressure reduction spaces S2 from outside.

In a central portion of the wafer holder 300 of the third embodiment, a rhombic passage hole 316 is formed to enable a chuck portion 360 of a transfer stage 350 to pass through. Therefore, due to the passage hole 316, there are disconnected parts in the support portions 311 and groove portions 312 passing through the central portion of the wafer holder 300. Hence, a plurality of hole-side connection portions 317 are each formed to connect one adjacent pair of the support portions 311 at a portion in connection with the passage hole 316. Thus, the hole-side connection portions 317 close up the disconnected parts of the groove portions 312 due to the passage hole 316 so as to prevent inflow of air or gas into the above pressure reduction spaces S2 from outside. Further, each of the hole-side connection portions 317 is formed into a wall shape extending along the periphery of the passage hole 316.

Further, in the bottoms of the groove portions 312, suction holes 314 are formed for sucking air from the respective pressure reduction spaces S2. The suction holes 314 are arranged respectively in the bottoms of the groove portions 312, and in the vicinity of the connection portions 313, i.e., in the portion of the wafer holder 300 supporting the area other than the observation area T1 (the area outside of the observation area T1), and formed to extend downward from the bottoms of the groove portions 312. The lower ends of the suction holes 314 are connected respectively to an internal passage 315 formed inside the wafer holder 300, while the internal passage 315 is connected to the unshown vacuum source via a vacuum piping (not shown) fitted below the wafer holder 10.

Further, outer support portions 311′ are each formed into an arc shape according to the outer-periphery shape of the wafer W so as to support areas of the left and right ends of the wafer W in FIGS. 13(a) and 13(b), while being each connected to both ends of the adjacent support portion 311 so as to form a semicircular outer groove portion 312′ on the inner-periphery side. A pressure reduction space S2 is also formed with each of these outer groove portions 312′ to be enclosed by the wafer W, and the support portion 311 and support portion 311′ positioned on both sides of the corresponding outer groove portion 312′, while in the bottoms of the outer groove portions 312′, outer suction holes 314′ are formed for sucking air from the corresponding pressure reduction spaces S2.

Further, a black coating capable of absorbing infrared rays is applied to the surface of the upper-end portion (front-end portion) of the wafer holder 300 where the support portions 311, groove portions 312 and the like are formed. Further, without being limited to a black coating, it is possible to form a layer of any suitable infrared absorber on the upper-end surface of the wafer holder 300. For example, as the infrared absorber, it is also possible to apply or attach carbon black, diimmonium salt, aminium salt, or the like, to the surface of the wafer holder 300. Further, black SiC (silicon carbide) may also be used to form the wafer holder 300.

Below the wafer holder 300, the transfer stage 350 is provided to receive the wafer W transported there by the third transport device 71 and transfer the same to the wafer holder 300. The transfer stage 350 is configured to include a chuck portion 360 which sucks and holds the wafer W, a raising and lowering portion 370 which vertically moves (raises and lowers) the chuck portion 360. The chuck portion 360 is formed into a rhombus a little smaller than the passage hole 316 of the wafer holder 300 and, in the same manner as the wafer holder 300, configured to have support portions, groove portions, connection portions and the like to be capable of sucking the wafer W.

The upper end of a vertically extending support shaft 365 is connected to the lower end of the chuck portion 360, while the lower end of the support shaft 365 is connected to a plate-like raising and lowering base 366 fitted on the nut of a ball screw 372. By virtue of this, the chuck portion 360 is connected with the raising and lowering portion 370 via the support shaft 365 and raising and lowering base 366. The raising and lowering portion 370 is configured to have a motor 371, and the ball screw 372 which receives the rotary force of the motor 371 to vertically move the raising and lowering base 366, so as to be capable of vertically moving (raising and lowering) the chuck portion 360 along with the raising and lowering base 366 and support shaft 365.

With the wafer holder 300 of the third embodiment configured in the above manner, in order to receive the wafer W transported by the third transport device 71, first, the chuck portion 360 of the transfer stage 350 is inserted through the passage hole 316 of the wafer holder 300 and raised up to the first transfer position set to be above and apart from the wafer holder 300. Then, at the first transfer position, while the third transport device 71 (wafer holding device 73) releases the holding of the edge portions of the wafer W, the chuck portion 360 chucks the back side of the wafer W. Next, the wafer W held by the chuck portion 360 is lowered along with the chuck portion 360 down to the wafer holder 300, where the chuck portion 360 releases the chucking of the back side of the wafer W while the wafer holder 300 chucks the back side of the wafer W. Then, by lowering the chuck portion 360 below the wafer holder 300, it is possible to hold the wafer W on the wafer holder 300 while causing the tilt mechanism 9 to tilt the wafer holder 300.

On the other hand, in order to transfer the wafer W from the wafer holder 300 to the third transport device 71, first, the chuck portion 360 of the transfer stage 350 is raised up to the same height as the wafer holder 300, where the wafer holder 300 releases the chucking of the back side of the wafer W while the chuck portion 360 chucks the back side of the wafer W. Then, the wafer W held by the chuck portion 360 is raised along with the chuck portion 360 up to the first transfer position, where the chuck portion 360 releases the chucking of the back side of the wafer W while the third transport device 71 (wafer holding device 73) holds edge portions of the wafer W. Further, the wafer holder 300 as well as the chuck portion 360 chucks the back side of the wafer W and releases the chucking of the back side of the wafer W in the same manner as in the first embodiment.

The wafer holder 300 of the third embodiment is similar to the wafer holder 10 of the first embodiment in the shapes and the like of the support portions 311 and groove portions 312, but different therefrom in that the rhombic passage hole 316 is formed in the central portion. This passage hole 316 is arranged such that the diagonals of the rhombus may extend along the incidence plane of the illumination light to the wafer W, while the lateral sides of the passage hole 316, the edge lines along the edges of the passage hole 316, and the like are configured to extend obliquely (not vertically) to the incidence plane of the illumination light. By virtue of this, even when any reflected and scattered infrared light arises from the edges (the parts of the edge lines) of the passage hole 316 and hole-side connection portions 317, because the perpendicular to the edges does not extend parallel to the incidence plane of the illumination light (that is, toward the light receiving system 30), most of the reflected and scattered light arising from the edges proceeds in a different direction from the propagation direction of the diffracted light arising from the pattern A (that is, the light-receiving direction of the light receiving system 30), thereby becoming less likely to reach the light receiving system 30. In this manner, in the portion of the wafer holder 300 supporting the observation area T1 of the wafer W, the wafer holder 300 of the third embodiment is configured not to have any lines or planes orthogonal to the incidence plane of the illumination light to the wafer W. Therefore, in the same manner as in the first embodiment, it is possible to prevent detection of the reflected and scattered light arising from the wafer holder 300, thereby allowing the inspection precision to be improved. Further, the passage hole 316 (as well as the chuck portion 360) is not necessarily rhombic, but may take on any shape as far as it is arranged in the observation area T1 without forming any lines or planes orthogonal to the incidence plane of the illumination light to the wafer W. For example, the passage hole 316 (as well as the chuck portion 360) may be formed either into an octagon, or a tetragon which superimposes the bases of two isosceles triangles different in height from each other. Further, it is not necessary to arrange the passage hole 316 (as well as the chuck portion 360) such that the diagonals of the rhombus may extend along the incidence plane of the illumination light to the wafer W, but it is possible to arrange the same at any angle as far as it is arranged in the observation area T1 without forming any lines or planes orthogonal to the incidence plane of the illumination light to the wafer W. For example, the passage hole 316 (as well as the chuck portion 360) may be arranged to be a few degrees (5 to 10 degrees) inclined from the arrangement shown in FIG. 13(a).

Further, in the third embodiment described above, it is configured to suck and hold the wafer W on the wafer holder 300 by sucking the air from the pressure reduction spaces S2 enclosed by the support portions 311 and wafer W to reduce the pressures inside the pressure reduction spaces S2. However, the present invention is not limited to this but, as described in the second embodiment, may be configured to use electrostatic force to suck and hold the wafer W on the wafer holder. Further, in the same manner, the chuck portion 360 of the transfer stage 350 may also be configured to use electrostatic force to suck and hold the wafer W.

Further, in the third embodiment described above, like the first embodiment, it is also possible either to form each of the support portions into a tapered shape, or to form the wafer holder of a porous material. Further, instead of the connection portions, pressure reduction auxiliary portions may be provided to prevent inflow of air or gas into the pressure reduction spaces S2 from outside.

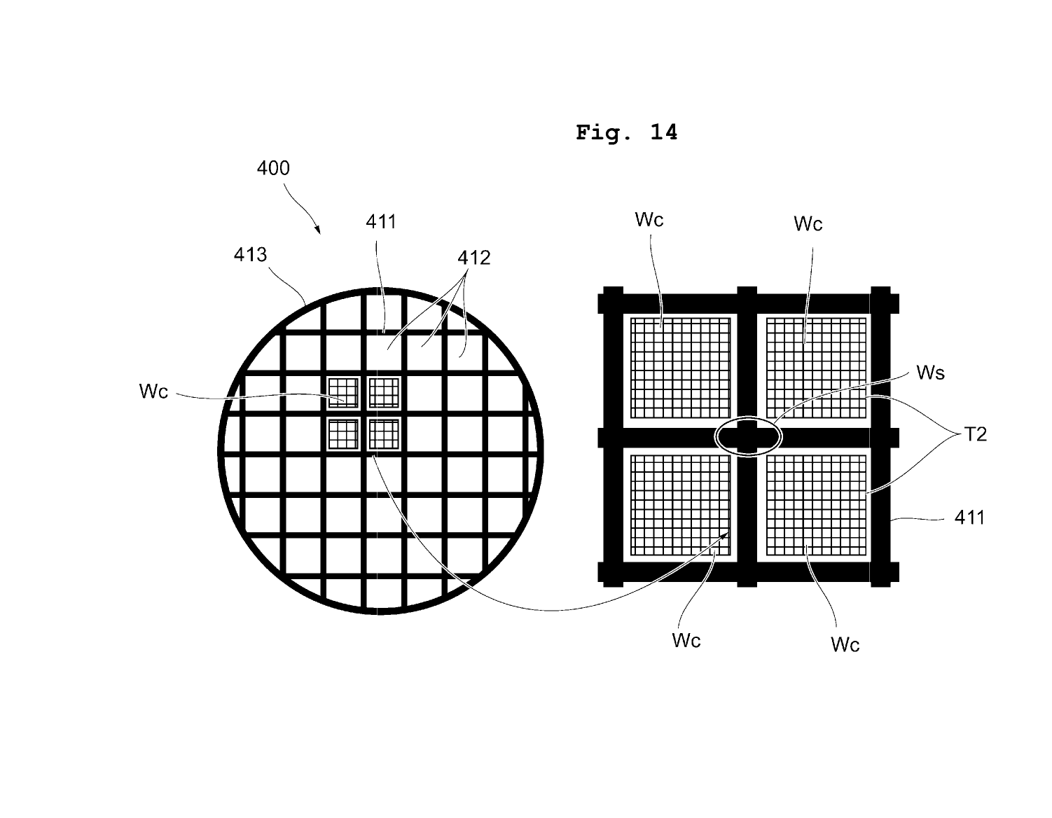

Next, referring to FIGS. 14 and 15, a fourth embodiment of the inspection apparatus will be explained. The inspection apparatus of the fourth embodiment has the same configuration as the inspection apparatus 1 of the first embodiment except for the wafer holder. Therefore, the same reference numeral is assigned to each of the other portions as in the first embodiment while detailed explanation will be omitted. Further, in the fourth embodiment, an observation area T2 refers to an area of the wafer W where chips Wc (the pattern A) are formed, and streets Ws formed between the respective chips Wc are supposed to be not included in the observation area T2. Using ceramic or the like, a wafer holder 400 of the fourth embodiment is formed into an approximately circular disk to fit the shape of the wafer W. The upper-end portion (front-end portion) of the wafer holder 400 is formed with protruding support portions 411 to contact with the wafer W when supporting the wafer W, and separate portions 412 apart from the wafer W.

As shown in FIG. 14, the support portions 411 are formed into parallel crosses extending in a crisscross manner so as to contact with the back sides of the streets Ws of the wafer W. Further, the support portions 411 are smaller in width than the streets Ws. Further, because generally the chips Wc do not change in size with each wafer W of the same type, it is possible to uniformly determine the width and interval of the support portions 411 formed in parallel crosses. The plurality of separate portions 412 are formed to be partitioned by the support portions 411 formed in parallel crosses.

Then, as shown in FIG. 15, with the wafer W being supported by the wafer holder 400, a pressure reduction space S3 is formed with each of the separate portions 412 to be enclosed by the wafer W and the support portions 411. By sucking the air from the pressure reduction spaces S3 formed respectively with the separate portions 412 to reduce the pressures inside the pressure reduction spaces S3, the wafer W is sucked and held on the wafer holder 400. Further, as shown in FIG. 14, an annular connection portion 413 is formed to connect the corresponding ends of the adjacent support portions 411 at a portion of the wafer holder 400 supporting the peripheral portion of the wafer W (where the chips Wc are not formed) and, by this connection portion 413, the abovementioned pressure reduction spaces S3 are also formed with the separate portions 412 positioned in the peripheral portion of the wafer holder 400.

Further, as shown in FIG. 15, in the bottom of each of the separate portions 412, a suction hole 414 is formed for sucking air from the corresponding pressure reduction space S3. The suction holes 414 are formed to extend downward from the bottoms of the separate portions 412, and connected respectively to the unshown vacuum source via an internal passage and vacuum piping (not shown) of the wafer holder 400. Further, the suction holes 414 may also be each formed into a rhombus whose diagonals extend along the incidence plane of the illumination light to the wafer W.

Further, a black coating capable of absorbing infrared rays is applied to the surface of the upper-end portion (front-end portion) of the wafer holder 400 where the support portions 411, separate portions 412 and the like are formed. Further, without being limited to a black coating, a layer of any suitable infrared absorber may be formed on the upper-end surface of the wafer holder 400 as necessary. For example, as the infrared absorber, it is also possible to apply or attach carbon black, diimmonium salt, aminium salt, or the like, to the surface of the wafer holder 400. Further, black SiC (silicon carbide) may also be used to form the wafer holder 400.

With the wafer holder 400 of the fourth embodiment configured in the above manner, in order to chuck the back side of the wafer W, with the back side of the wafer W being in contact with the wafer holder 400, the unshown vacuum source is used to suck the air, via the suction holes 414, from the pressure reduction spaces S3 formed respectively with the separate portions 412 of the wafer holder 400. By virtue of this, the air pressures inside the pressure reduction spaces S3 are reduced, and thus the wafer W is sucked and held on the wafer holder 400. On the other hand, in order for the wafer holder 400 to release the chucking of the back side of the wafer W, after the tilt mechanism 9 restores the wafer holder 400 to an approximately horizontal state, the unshown gas supply device, switching valve and the like are used to supply air or a gas from the suction holes 414 to the aforementioned pressure reduction spaces S3 formed in the wafer holder 400. By virtue of this, the reduced pressures inside the pressure reduction spaces S3 return to the atmospheric pressure, thereby releasing the wafer W from being sucked by the wafer holder 400.

In the wafer holder 400 of the fourth embodiment, the protruding support portions 411 are formed in parallel crosses to contact with the back sides of the streets Ws which are not included in the observation area T2, and configured not to have any lines or planes orthogonal to the incidence plane of the illumination light to the wafer W in the portion of the wafer holder 400 supporting the observation area T2 of the wafer W. By virtue of this, even when the reflected and scattered light arising from the edges and the like of the support portions 411 reaches the imaging section 35, it is only reflected in the part of the streets Ws which are not included in the observation area T2, but not reflected in the observation area T2 in which the chips Wc are formed. Therefore, in the same manner as in the first embodiment, it is possible to prevent detection of the reflected and scattered light arising from the wafer holder 400, thereby allowing the inspection precision to be improved. Further, because the support portions 411 can be arranged uniformly, it is possible to suck and hold the wafer W without giving rise to any deflection.

Further, in the fourth embodiment described above, it is configured to suck and hold the wafer W on the wafer holder 400 by sucking the air from the pressure reduction spaces S3 enclosed by the support portions 411 and wafer W to reduce the pressures inside the pressure reduction spaces S3. However, without being limited to this configuration, it may also be configured to use electrostatic force to suck and hold the wafer W on the wafer holder as described in the second embodiment. Further, when the streets Ws are narrow, then it is necessary to narrow the support portions 411 too. When the streets Ws are each narrower than a predetermined width, then it becomes practically difficult to use the streets Ws for the support. Hence, it can be said that the fourth embodiment is effective for the streets Ws which are each broader than the predetermined width. On the other hand, in the fourth embodiment, even when the wafer W is turned over and then held by the wafer holder, because the support portions 411 still do not overlap the pattern, the diffraction inspection may also be carried out from the surface (back surface) on the opposite side to the surface (front surface) where the pattern A is formed.

Further, in each of the abovementioned embodiments, the wafer holding device 73 holds edge portions of the wafer W by rotating the holding members 77 where the engagement grooves 77a are formed. However, without being limited to this configuration, for example, the wafer holding device 73 may include a pair of holding members which are slidable in mutually opposite horizontal directions, a pair of rod-like members on which rack gears are formed and which are connected respectively to the holding members, a pinion gear which has engaged the respective rack gears, and a motor which rotationally drives the pinion gear, to let the holding members hold edge portions of the wafer W or release the holding of the edge portions of the wafer W by causing the motor to rotate the pinion gear so as to slide the pair of rod-like members and the pair of holding members in the horizontal directions. Further, when there is no negative influence on the surface side of the wafer W, then it is also possible to chuck the surface of the wafer W.

Further, in each of the abovementioned embodiments, the wafer holder sucks and holds the wafer W (from the back side of the wafer W) with its surface facing upward. However, without being limited to this configuration, the wafer W may also be turned over and then held by the wafer holder, and the diffraction inspection may be carried out from the surface (back surface) on the opposite side to the surface (front surface) where the pattern A is formed. On this occasion, further, it is desirable to use a thin-film protector to cover and protect the surface of the wafer W where the pattern A is formed. On this occasion, furthermore, it is desirable to grind the back surface of the wafer W into a specular surface. Moreover, it is desirable to control the back surface of the wafer W so as not to let any dirt and the like adhere thereto. The reason is that because the illumination light passes through the back surface of the wafer W twice, when this surface is a scattering surface (not ground), or when some dirt and the like adhere to this surface, then the inspection is subject to encounter with obstruction.

Further, in each of the abovementioned embodiments, the diffracted light arising from the pattern A of the wafer W is detected to carry out the inspection of the wafer W. However, without being limited to this configuration, for example, it is also possible to detect a state change in the polarized light due to the structural birefringence arising from the pattern A of the wafer W. It is possible to detect a state change in the polarized light due to the structural birefringence by arranging a polarization element in each of the optical paths of the illumination system 20 and light receiving system 30 to form a crossed-Nicol relationship between the polarization element of the illumination system 20 and the polarization element of the light receiving system 30. Further, sensitivity may be improved by deviating the relationship between the polarization element of the illumination system 20 and the polarization element of the light receiving system 30 from the crossed Nicol according the polarization state of the reflected light. Further, for example, it is also possible to detect the regular reflection light or scatted light from the front surface (or back surface) of the wafer W.

Further, in each of the abovementioned embodiments, the illumination system 20 (illumination unit 21) is configured to irradiate the wafer W with the illumination light of a specific wavelength. However, without being limited to this configuration, the illumination system 20 (illumination unit 21) may also be configured to irradiate the wafer W with white light in a range including near-infrared light, and let a wavelength selection filter be appropriately inserted right in front of the imaging section 35 to only transmit the light (diffracted light) of the specific wavelength.

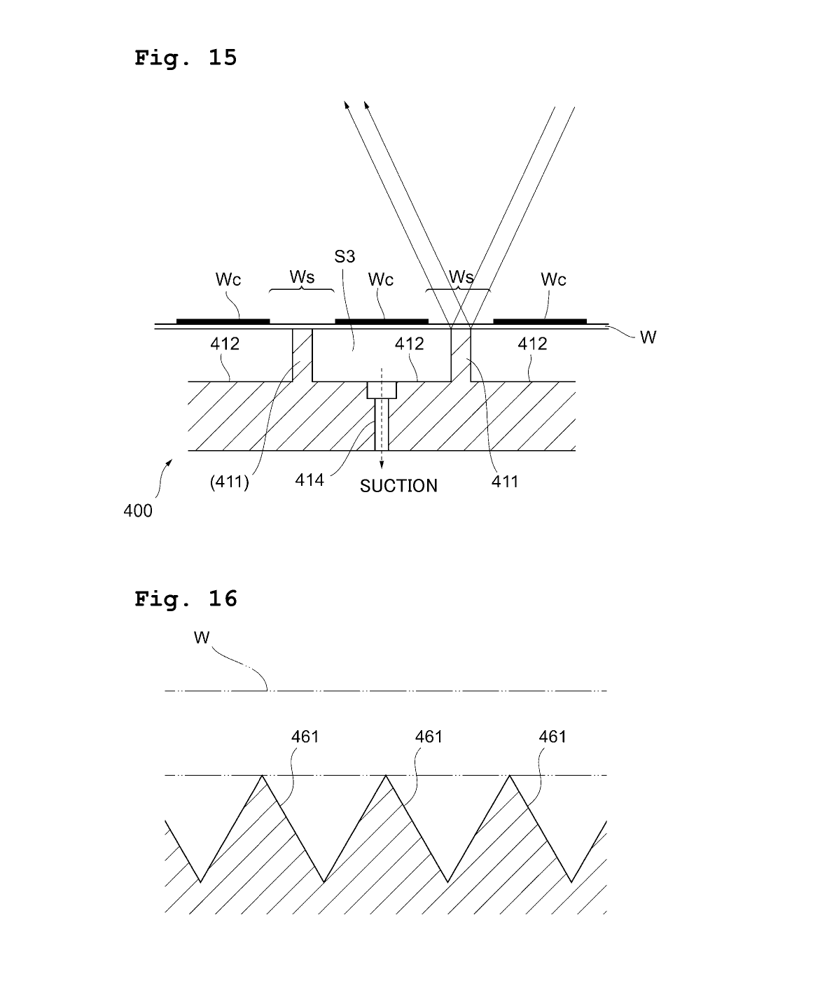

Further, in each of the abovementioned embodiments, the wafer holder sucks and holds the wafer W. However, without being limited to this configuration, when it is not necessary to suck and hold the wafer W for example, then the wafer holder may also be configured to just support the wafer W. On such an occasion, moreover, a plurality of support portions 461 aligned approximately parallel to one another, as shown in FIG. 16, may be each formed into a pentahedron which is a triangle in a sectional view, to continuously support the wafer W from one end to the other end, and be arranged to extend along the incidence plane of the illumination light to the wafer W.

Further, in each of the abovementioned embodiments, the explanations are made with an example of the inspection apparatus which includes an inspection section (the image processing section 41) to carry out inspection of the wafer W based on the detection signal (image signal) detected by the imaging section 35. However, without being limited to this configuration, it is also possible to apply the present invention to any observation devices which observe the image of the wafer W acquired by the imaging section 35 without including such observation section. Further, in each of the abovementioned embodiments, the explanations are made with an example of the pattern A formed with the holes (or vias) which are arranged regularly. However, the inspection objects are not limited to this pattern, but may be any patterns having such a depth as formed from a surface of a substrate in an orthogonal direction to the surface. For example, without being limited to hole patterns, it is also possible to adopt line and space patterns. Further, in each of the abovementioned embodiments, concave mirrors are used as the illumination-side concave mirror 25 and light-receiving-side concave mirror 31. However, without being limited to this configuration, it is also possible to replace the same with lenses. Further, while the light source is a built-in type in each of the abovementioned embodiments, it is also possible to use a fiber or the like to input light generated outside.

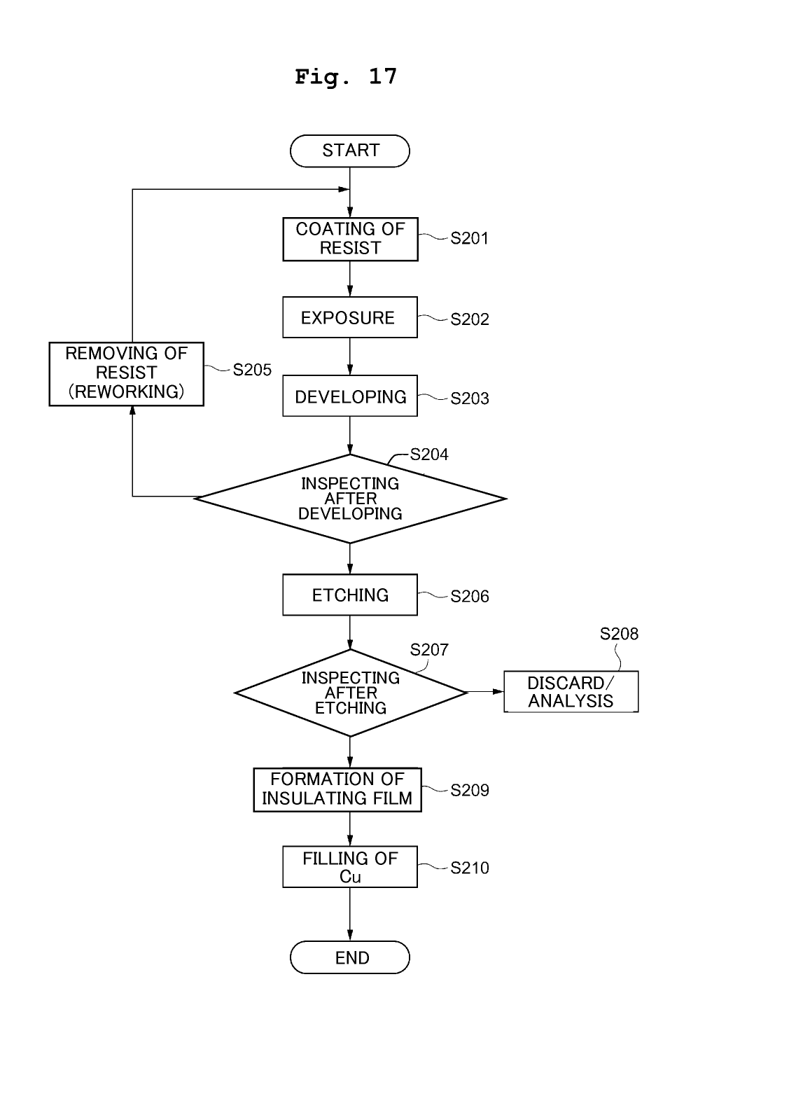

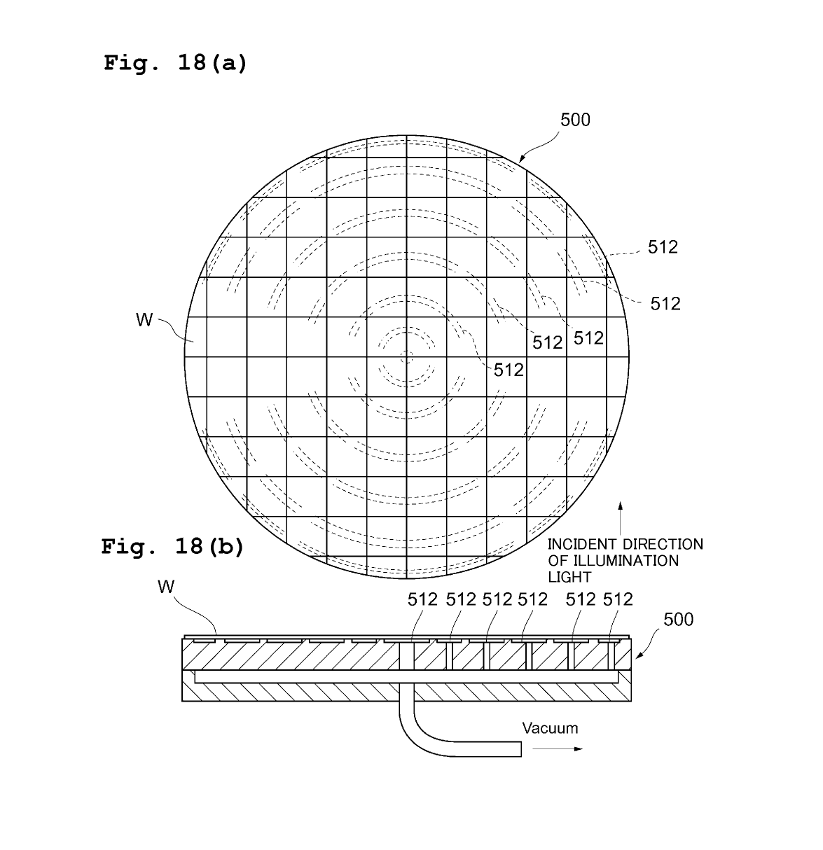

Next, referring to the flowchart shown in FIG. 17, explanations will be given about a method for manufacturing a semiconductor device where the wafer W is inspected by the aforementioned inspection apparatus. The flowchart of FIG. 17 shows a process for forming TSVs in the semiconductor device of a three-dimensional lamination type. In this TSV formation process, first, a resist is coated to the surface of a wafer (a bare wafer or the like) (step S201). In this resist coating process, a resist coating device (not shown) is used, for example, to fix the wafer on a rotary support table with a vacuum chuck or the like, and rotate the wafer at a high speed to form a thin resist film after dropping liquid photoresist from a nozzle onto the surface of the wafer.

Next, a predetermined pattern (a hole pattern) is exposed and projected to the wafer surface to which the resist has been coated (step S202). In this exposure process, an exposure device is used, for example, to irradiate the resist on the wafer surface with a light beam of a predetermined wavelength (an energy beam such as an ultraviolet beam or the like) through a photomask formed with the predetermined pattern, so as to transfer the mask pattern to the wafer surface.

Next, development is carried out (step S203). In this development process, a developing device (not shown) is used, for example, to carry out a process for dissolving the resist in the exposed portion with a solvent, and preserving the resist pattern in the unexposed portion. By virtue of this, the hole pattern is formed with the resist on the wafer surface.

Next, inspection is carried out on the wafer surface formed with the resist pattern (hole pattern) (step S204). In the inspection process after development, a surface inspection apparatus (not shown) is used, for example, to irradiate the entire wafer surface with illumination light, take an image of the wafer with the diffracted light arising from the resist pattern, and inspect whether or not there is any abnormity in the resist pattern and the like from the image taken from the wafer. This inspection process determines whether or not the resist pattern is nondefective. When the resist pattern is defective, then it is determined whether or not to rework the wafer, i.e., to take an action of removing the resist and treating the wafer over again from the resist coating process. When detecting some abnormity (defection) for which the rework is needed, the resist is removed (step S205) and the process from step S201 to step S203 is carried out over again. Further, the inspection result from the surface inspection apparatus is fed back to the resist coating device, the exposure device, and the developing device, respectively.

When it is confirmed that no abnormity is present in the inspection process after development, then etching is carried out (step S206). In this etching process, an etching device (not shown) is used, for example, to mask the preserved resist and remove the silicon part of the bare-wafer base to form the holes for TSV formation. By virtue of this, the repetitive pattern A, which is constituted by the holes for TSV formation, is formed in the surface of the wafer W.

Next, inspection is carried out on the wafer W with the pattern A formed by etching (step S207). The inspection process after etching is carried out by the inspection apparatus according to any of the aforementioned embodiments. In this inspection process, when some abnormity is detected, then according to the type and degree of the abnormity including the depth of the detected abnormity, it is determined to adjust which of the exposure conditions for the exposure device (deformation illumination condition, focus offset condition and the like) and/or which part of the etching device, whether or not to discard the wafer W, and/or whether or not to require a detailed analysis such as further breaking the wafer W to observe its cross section. When a serious and extensive abnormity is discovered in the wafer W after etching, then the wafer W cannot be reworked, and thus should be either discarded or diverted to analysis such as cross section observation and the like (step S208).

When it is confirmed that no abnormity is present in the inspection process after etching, then an insulation film is formed on the sidewall of each hole (step S209), and the portion of each hole formed with the insulation film is filled with a conductive material such as Cu or the like (step S210). By virtue of this, TSVs are formed in the wafer (bare wafer).

Further, the inspection result from the inspection process after etching is fed back primarily to the exposure device and the etching device. When some abnormity has been detected in the cross-sectional shape of the holes and/or in the diameter of the holes, then the feedback is carried out to provide information for focus and/or dose adjustment of the exposure device, while when there is some abnormity in the hole shape in the depth direction and/or in the hole depth, then the feedback is carried out to provide information for adjusting the etching device. In the etching process for TSV formation, because it is necessary to form the holes with a high aspect ratio (depth/diameter) (such as 10 to 20), which is technically difficult, it is important to carry out those adjustments based on the feedbacks. In this manner, in the etching process, it is required to form deep holes at a nearly vertical angle and, in recent years, a method called RIE (Reactive Ion Etching) is widely adopted. In the case of inspection after etching, it is monitored whether or not there is any abnormity in the etching device. When some abnormity is detected, then such a feedback operation is mainly carried out as to shut down the etching device and adjust the same. As the parameters for adjusting the etching device, for example, the following ones are conceivable: the parameter for controlling the etching rate ratio between the vertical and horizontal directions, the parameter for controlling the depth, the parameter for controlling the uniformity within the wafer surface, and the like.

Further, when the inspection process after development is carried out, then any abnormity in the resist application device, exposure device or developing device is basically detected in the inspection process after development. However, when the inspection process after development is not carried out, or if any problem in those devices is discovered for the first time through the etching, then feedback to each device (adjustment of each device) is carried out.

On the other hand, it is also possible to feed forward the inspection result from the inspection process after etching to the succeeding processes. For example, when some chips of the wafer W are determined to be abnormal (defective) in the inspection process after etching, then that information is transmitted online from the aforementioned inspection apparatus 1 to the host computer (not shown) in control of the process, and is stored there for use in management such as in the case of not using the abnormal part (chips) in the inspection and measurement of the succeeding processes, etc., or for application in the case of not carrying out unnecessary electrical test at the stage of final completion of the device, etc. Further, when the abnormal part has a large area according to the inspection result from the inspection process after etching, then it is possible to use the information to reduce the influence on the nondefective part, etc., by accordingly adjusting the parameter for forming the insulation film or for filling of Cu.

According to the method for manufacturing the semiconductor device in accordance with the present embodiment, because the inspection apparatus according to the aforementioned embodiments is used to carry out the inspection process after etching, it is possible to carry out the inspection based on the image of the wafer W with little noise, thereby improving the inspection precision. Hence, it is possible to improve the efficiency of manufacturing the semiconductor device.

Further, in the aforementioned TSV formation process, TSVs are formed at the initial stage before forming any elements on the wafer. However, without being limited to this sequence, the TSVs may also be formed either after forming the elements or in the course of forming the elements. Further, in such case, implanting ions, etc., in the process of forming the elements may result in decreasing the degree of transparency for infrared but does not lead to complete opaqueness. Therefore, considering the change in transparency, it is only necessary to select the wavelength and/or adjust the amount of illumination light. Further, even on a production line using such method, as a condition required for the line and for QC purpose, when TSVs are formed in a bare wafer and inspection is carried out, then it is possible to carry out the inspection without being affected by the decrease in transparency due to the ion implantation.

### INDUSTRIAL APPLICABILITY

It is possible to apply the present invention to the inspection apparatus which is used in the inspection process after etching for manufacturing a semiconductor device. By virtue of this, it is possible to improve the inspection precision of the inspection apparatus, thereby being able to improve the efficiency of manufacturing the semiconductor device.

### REFERENCE SIGNS LIST

1 Inspection apparatus
9 Tilt mechanism (rotary section)
10 Wafer holder (first embodiment)
11 Support portion (11a Support surface, 11b Lateral side, 11c Edge line)
12 Groove portion (separate portion)
13 Connection portion (pressure reduction auxiliary portion)
14 Suction hole
16 Relief portion
20 Illumination system (illumination section)
30 Light receiving system (detection section)
35 Imaging section (detection section)
40 Control section
41 Image processing section (inspection section)
50 Transport unit
51 First transport device
61 Second transport device
71 Third transport device
73 Wafer holding device
77 Holding member
80 Wafer holder (modification of first embodiment)
86 Relief portion
90 Wafer holder (modification of first embodiment)
91 Support portion (91b Lateral side)
92 Groove portion (separate portion)
101 Support portion (101a Support surface, 101b Lateral side)
102 Groove portion (separate portion)
104 Suction hole
200 Wafer holder (second embodiment)
211 Support portion
212 Groove portion (211a Support surface, 211b Lateral side, 211c Edge line)
216 Relief portion
250 Wafer holder (modification of second embodiment)
261 Support portion (261a Support surface, 261b Lateral side, 261c Edge line)
262 Separate portion
300 Wafer holder (third embodiment)
311 Support portion
312 Groove portion (separate portion)
313 Connection portion
314 Suction hole
400 Wafer holder (fourth embodiment)
411 Support portion
412 Separate portion
413 Connection portion
414 Suction hole
461 Support portion (modification)
500 Wafer holder (conventional example)
C Wafer carrier
W Wafer
A Pattern
Wc Chip
Ws Street
S1 to S3 Pressure reduction space
T1 and T2 Observation area

1. An observation apparatus comprising:
a substrate support member configured to support a substrate;
an illumination section configured to irradiate the substrate supported by the substrate support member with an illumination light having transmittance with respect to the substrate; and
a light detection section configured to detect light from the substrate irradiated with the illumination light,
wherein the substrate support member has a protruding support portion which contacts with the substrate when supporting the substrate, and a separate portion which is located apart from the substrate; and
wherein in a part of the substrate support member supporting an observation area to be observed on the substrate, the support portion and the separate portion of the substrate support member do not have any line or plane orthogonal to an incidence plane of the illumination light to the substrate.

2. The observation apparatus according to claim 1, wherein the illumination light includes infrared light of a wavelength equal to or longer than 700 nm.

3. The observation apparatus according to claim 1—further comprising a transport device transporting the substrate to the substrate support member, wherein the transport device has a holding member which holds an edge portion of the substrate when transporting the substrate; the substrate support member has a relief portion formed not to contact with the holding member when the transport device transports the substrate to the substrate support member; and the substrate support member is arranged not to have any line or plane orthogonal to the incidence plane of the illumination light in a part of the relief portion supporting the observation area.

4. The observation apparatus according to claim 1, wherein the substrate support member is configured to suck and hold the substrate by sucking air from a space formed by the supported substrate and the support portion so as to cause pressure reduction in the space; and a suction portion is provided to suck the air in a part of the substrate support member supporting the other area than the observation area.

5. The observation apparatus according to claim 4, wherein between the support portion and another support portion adjacent to the former support portion, a pressure reduction auxiliary portion is provided to prevent inflow of air or gas from outside into the space formed by the supported substrate and the support portions.

6. The observation apparatus according to claim 1, wherein the support portion extends along the incidence plane of the illumination light.

7. The observation apparatus according to claim 1, wherein the support portion has a linear portion extending from one end to the other end of the observation area along the incidence plane of the illumination light.

8. The observation apparatus according to claim 1 further comprising a rotary section which is configured to rotate the substrate support member around an axis vertical to the incidence plane of illumination light.

9. The observation apparatus according to claim 1, wherein on a surface of the substrate support member facing the substrate, a layer of an infrared absorber is formed to absorb infrared.

10. The observation apparatus according to claim 2, wherein the light detection section has a cooled image sensor.

11. The observation apparatus according to of claim 1, wherein the illumination section has a telecentric optical system which is configured to cause the illumination light to become parallel light to illuminate the substrate.

12. An inspection apparatus comprising:
the observation apparatus as defined in claim 1; and
an inspection section which is configured to inspect whether or not there is an abnormity in the substrate based on a detection signal of the light detected by the light detection section of the observation device.

13. A method for manufacturing a semiconductor device, comprising:
exposing a predetermined pattern onto a surface of a substrate;
etching the surface of the substrate according to the exposed pattern; and
inspecting the substrate with the pattern formed in the surface through the exposing or the etching,
wherein the inspection apparatus as defined in claim 12 is used to carry out the inspecting.

14. A substrate support member comprising:
protruding support portions which are configured to support a substrate by contact with the protruding support portions; and
a separate portion which is located apart from the substrate,
wherein the protruding support portions extend continuously from a part supporting one end of the substrate to a part supporting the other end, and have connection portions which connect adjacent ones of the protruding support portions, respectively in the vicinity of the part supporting the one end and in the vicinity of the part supporting the other end.

15. The substrate support member according to claim 14, wherein the protruding support portions are each formed into an approximate cuboid.

16. The substrate support member according to claim 14, wherein in the vicinity of each of the connection portions and in the ambit enclosed by the adjacent ones of the protruding support portions and the connection portions, a suction portion is provided to be capable of sucking air from a space formed by the supported substrate and the support portions.

17. An observation apparatus comprising:
a substrate support member configured to support a substrate;
an illumination section configured to irradiate the substrate supported by the substrate support member with illumination light having transmittance with respect to the substrate; and
a light detection section configured to detect light from the substrate irradiated with the illumination light,
wherein the substrate support member has a protruding support portion which contacts with the substrate when supporting the substrate, and a separate portion which is located apart from the substrate; and
wherein in a part of the substrate support member supporting an observation area to be observed on the substrate, the support portion and the separate portion of the substrate support member intersect an incidence plane of the illumination light to the substrate at an acute angle or obtuse angle.
